(19) United States
(12) Patent Application Publication
(10) Pub. No.: US 2024/0281686 A1
(43) Pub. Date: Aug. 22, 2024

(54) INPUT-BASED MODIFICATION OF A QUANTUM CIRCUIT

(71) Applicant: Classiq Technologies LTD., Tel Aviv (IL)

(72) Inventors: Amir Naveh, Haifa (IL); Shmuel Ur, Shorashim (IL); Eyal Cornfeld, Ramat Gan (IL); Ofek Kirzner, Haifa (IL); Yehuda Naveh, Tel-Aviv Yafo (IL)

(21) Appl. No.: 18/110,516

(22) Filed: Feb. 16, 2023

(51) Int. Cl. G06N 10/20

(52) U.S. Cl. CPC G06N 10/20

(57) ABSTRACT

A method, system, and product, the method including obtaining quantum state data from a simulation of a portion of a quantum circuit. The portion of the quantum circuit is configured to prepare input values on input qubits of the quantum circuit. The portion of the quantum circuit is configured to produce an output value based on a manipulation of the input qubits when having the input values, with the quantum state data including the input values and the output value. The method further includes, based on the quantum state data, determining a modification of the quantum circuit. Based on the determining of the modification of the quantum circuit, the method generates a modified quantum circuit that is configured to produce the output value. The method then includes executing the modified quantum circuit on a quantum computer.

### TECHNICAL FIELD

The present disclosure relates to quantum computing in general, and to modifying a representation of a quantum circuit based on input values of the quantum circuit, in particular.

### BACKGROUND

Quantum computing is a computational paradigm that is fundamentally different from classical computing. In contrast to classical computing, which utilizes bits, quantum computing utilizes qubits. The qubits have unique features, as each qubit can be in superposition, several qubits can be entangled, and all operations on qubits besides measurement, referred to as quantum gates, must be reversible. Temporarily computed values are stored on additional helper qubits, referred to as auxiliary qubits.

A qubit is the physical carrier of quantum information, which is referred to as the ‘quantum state’ of the qubit. A quantum state may comprise a mathematical entity that provides a probability distribution for the outcomes of each possible measurement on a system. A mixture of quantum states is, itself, a quantum state. Quantum states that cannot be written as a mixture of other states are called pure quantum states, while other states are called mixed quantum states. Qubits use the quantum mechanical phenomena of superposition to represent a sphere of values. For example, a qubit can represent a linear combination of two quantum state values, while being in superposition of both states.

### BRIEF SUMMARY

One exemplary embodiment of the disclosed subject matter is a method comprising: obtaining quantum state data that is determined based on a simulation of a portion of a quantum circuit, the quantum circuit is configured to manipulate a plurality of qubits over a plurality of cycles using a plurality of gates, the portion of the quantum circuit is configured to prepare one or more input values on one or more input qubits of the quantum circuit, the portion of the quantum circuit is configured to produce an output value based on a manipulation of the one or more input qubits when having the one or more input values, the quantum state data comprising the one or more input values and the output value; based on the quantum state data, determining a modification of the quantum circuit; based on said determining the modification of the quantum circuit, generating a modified quantum circuit, the modified quantum circuit is configured to produce the output value; and executing the modified quantum circuit on a quantum computer.

Optionally, said determining the modification comprises determining that a quantum gate of the quantum circuit is redundant for preparing the output value based on the quantum state data, wherein the quantum gate is not redundant for all potential input values of the quantum circuit and is redundant with respect to the one or more input values, wherein the modified quantum circuit is generated by removing the quantum gate from the quantum circuit.

Optionally, said determining the modification comprises determining that, when the quantum circuit is set with the one or more input values on the one or more input qubits, a two-qubit quantum gate of the quantum circuit can be replaced with a one-qubit quantum gate without affecting the output value, wherein the modified quantum circuit is generated by replacing the two-qubit quantum gate with the one-qubit quantum gate.

Optionally, said determining that the two-qubit quantum gate can be replaced with the one-qubit quantum gate comprises determining that first and second qubits of the plurality of qubits are attached to the two-qubit quantum gate, and, when the quantum circuit is set with the one or more input values on the one or more input qubits, the two-qubit quantum gate manipulates only the first qubit, and not the second qubit, wherein the one-qubit quantum gate is generated to be attached to the first qubit.

Optionally, said determining the modification comprises determining that, when the quantum circuit is set with the one or more input values on the one or more input qubits, a qubit of the quantum circuit can be reused, the quantum state data comprising a quantum state value of the qubit, wherein the modified quantum circuit is generated by inversing the quantum state value on the qubit.

Optionally, said determining the modification comprises determining that, when the quantum circuit is set with the one or more input values on the one or more input qubits, a subcircuit of the quantum circuit can be replaced with a set program, wherein the modified quantum circuit is generated by replacing the subcircuit with the set program.

Optionally, the subcircuit is configured to produce the output value, and the set program comprises a quantum state setter that prepares the output value.

Optionally, said determining that the subcircuit can be replaced with the set program is performed based on an identification that the subcircuit does not divide any purity sets, the identification is based on the quantum state data.

Optionally, the identification that the subcircuit does not divide any purity sets is based on a pure decomposition graph that is generated based on the quantum state data, wherein the pure decomposition graph indicates, for each stage of the simulation, which qubits of the quantum circuit belong to which purity sets.

Optionally, first and second qubits belong to a same purity set, wherein the first and second qubits are entangled with each other, wherein the first and second qubits are not entangled with any other qubit of the plurality of qubits.

Optionally, each of the qubits of the quantum circuit comprises an individual qubit or a qubit register.

Optionally, the pure decomposition graph comprises a Directed Acyclic Graph (DAG).

Optionally, the modification of the quantum circuit is configured to reduce a resource utilization of the quantum circuit when the quantum circuit is set with the one or more input values on the one or more input qubits, the resource utilization relating to at least one of: a qubit resource, a cycle resource, and a gate resource.

Optionally, said executing the modified quantum circuit is performed multiple times in order to measure an output of the modified quantum circuit.

Optionally, the output of the modified quantum circuit is identical to an output of the quantum circuit, whereby the modification of the quantum circuit does not affect the output of the quantum circuit.

Optionally, the portion of the quantum circuit is obtained by compiling a first subcircuit of the quantum circuit, and not compiling a second subcircuit of the quantum circuit.

Optionally, the second subcircuit is determined not to be compiled based on an estimation that a simulator that is configured to perform the simulation will exhaust a predetermined number of resources before simulating the second subcircuit.

Optionally, the quantum circuit comprises a first subcircuit and a second subcircuit, wherein the portion corresponds to the first subcircuit, and the method further comprises: compiling the first subcircuit, thereby obtaining a compiled portion; pausing a compilation process; performing said generating the modified quantum circuit, thereby modifying the first subcircuit to a modified first subcircuit; recompiling the modified first subcircuit; and continuing the compilation process to compile the second subcircuit, whereby the second subcircuit is only compiled once.

Another exemplary embodiment of the disclosed subject matter is an apparatus comprising a processor and coupled memory, said processor being adapted to: obtain quantum state data that is determined based on a simulation of a portion of a quantum circuit, the quantum circuit is configured to manipulate a plurality of qubits over a plurality of cycles using a plurality of gates, the portion of the quantum circuit is configured to prepare one or more input values on one or more input qubits of the quantum circuit, the portion of the quantum circuit is configured to produce an output value based on a manipulation of the one or more input qubits when having the one or more input values, the quantum state data comprising the one or more input values and the output value; based on the quantum state data, determine a modification of the quantum circuit; based on said determine the modification of the quantum circuit, generate a modified quantum circuit, the modified quantum circuit is configured to produce the output value; and execute the modified quantum circuit on a quantum computer.

Yet another exemplary embodiment of the disclosed subject matter is a system comprising a processor and coupled memory, said processor being adapted to: obtain quantum state data that is determined based on a simulation of a portion of a quantum circuit, the quantum circuit is configured to manipulate a plurality of qubits over a plurality of cycles using a plurality of gates, the portion of the quantum circuit is configured to prepare one or more input values on one or more input qubits of the quantum circuit, the portion of the quantum circuit is configured to produce an output value based on a manipulation of the one or more input qubits when having the one or more input values, the quantum state data comprising the one or more input values and the output value; based on the quantum state data, determine a modification of the quantum circuit; based on said determine the modification of the quantum circuit, generate a modified quantum circuit, the modified quantum circuit is configured to produce the output value; and execute the modified quantum circuit on a quantum computer.

Yet another exemplary embodiment of the disclosed subject matter is a computer program product comprising a non-transitory computer readable medium retaining program instructions, which program instructions when read by a processor, cause the processor to: obtain quantum state data that is determined based on a simulation of a portion of a quantum circuit, the quantum circuit is configured to manipulate a plurality of qubits over a plurality of cycles using a plurality of gates, the portion of the quantum circuit is configured to prepare one or more input values on one or more input qubits of the quantum circuit, the portion of the quantum circuit is configured to produce an output value based on a manipulation of the one or more input qubits when having the one or more input values, the quantum state data comprising the one or more input values and the output value; based on the quantum state data, determine a modification of the quantum circuit; based on said determine the modification of the quantum circuit, generate a modified quantum circuit, the modified quantum circuit is configured to produce the output value; and execute the modified quantum circuit on a quantum computer.

### THE BRIEF DESCRIPTION OF THE SEVERAL VIEWS OF THE DRAWINGS

The present disclosed subject matter will be understood and appreciated more fully from the following detailed description taken in conjunction with the drawings in which corresponding or like numerals or characters indicate corresponding or like components. Unless indicated otherwise, the drawings provide exemplary embodiments or aspects of the disclosure and do not limit the scope of the disclosure. In the drawings:

FIG. 1 depicts an exemplary instantiation process, in accordance with some exemplary embodiments of the disclosed subject matter;

FIG. 2 depicts an exemplary flowchart diagram of a method, in accordance with some exemplary embodiments of the disclosed subject matter;

FIGS. 3A-3B depict an exemplary modification of a quantum circuit, in accordance with some exemplary embodiments of the disclosed subject matter;

FIGS. 4A-4C depict exemplary modifications of a quantum circuit, in accordance with some exemplary embodiments of the disclosed subject matter;

FIGS. 5A-5B depict an exemplary pure decomposition graph, in accordance with some exemplary embodiments of the disclosed subject matter;

FIGS. 6A-6B depict exemplary selections of cuts in a pure decomposition graph, in accordance with some exemplary embodiments of the disclosed subject matter;

FIG. 7 depicts an exemplary effect of replacing a cut with a set program, in accordance with some exemplary embodiments of the disclosed subject matter;

FIG. 8A depicts an exemplary method of selecting cuts in a pure decomposition graph, in accordance with some exemplary embodiments of the disclosed subject matter;

FIG. 8B depicts an exemplary modification of a quantum circuit, in accordance with some exemplary embodiments of the disclosed subject matter;

FIG. 9 depicts an exemplary compilation process, in accordance with some exemplary embodiments of the disclosed subject matter;

FIG. 10 depicts an exemplary process for reusing a front-end compiler, in accordance with some exemplary embodiments of the disclosed subject matter;

FIGS. 11A-11B depict exemplary scenarios of using a function-level compiler, in accordance with some exemplary embodiments of the disclosed subject matter; and

FIG. 12 depicts an exemplary block diagram of an apparatus, in accordance with some exemplary embodiments of the disclosed subject matter.

### DETAILED DESCRIPTION

One technical problem dealt with by the disclosed subject matter is to reduce a number of resources that are used for executing a quantum circuit. In some exemplary embodiments, quantum circuits may be designed, programmed or created by a user, a programmer, an operator, or the like, using gate-level programming, using functional-level code, using high-level programming language, using evolutionary computing techniques such as Quantum Genetic Algorithm (QGA), using genetic algorithms, or the like. In some exemplary embodiments, after an initial quantum circuit is created, it may go through one or more stages, such as a compilation stage, before becoming an executable quantum circuit. In some exemplary embodiments, the executable quantum circuit may comprise a machine representation that can be executed by a quantum hardware compiler, a logical program circuit that can be simulated by a classical computer or engine, or the like. In some exemplary embodiments, executing a quantum circuit may utilize resources, such as time resources, quantum gate resources, qubit resources, cycle resources, or the like. It may be desired to reduce the number of resources that are used for executing a quantum circuit, while ensuring that the functionality of the quantum circuit is maintained. In some cases, the number of resources may relate to one or more weighted or non-weighted combinations of resources.

Another technical problem dealt with by the disclosed subject matter is to conserve resources that are used for executing a quantum circuit with the same inputs, for a plurality of times. In some exemplary embodiments, a quantum circuit may be wired or connected to multiple qubits, such as input qubits that constitute the logical input to the quantum circuit, auxiliary qubits that are not be part of a quantum function logic flow, or the like. In some exemplary embodiments, quantum circuits may be configured to manipulate states of the qubits, such as using quantum gates. In some exemplary embodiments, a quantum state may refer to quantum information (e.g., a linear combination of two states) that is carried by a qubit, a qubit register, or the like. Quantum states may include various types of states such as maximally-mixed states, maximally-entangled states, highly-entangled states, e.g., as disclosed in U.S. patent application Ser. No. 17/752,282, tiled “Auxiliary Qubit Verification In Quantum Circuits”, filed May 24, 2022, which is hereby incorporated by reference in its entirety without giving rise to disavowment.

In some exemplary embodiments, quantum circuits may refer to a gate-level or high-level representation of a quantum circuit that is not instantiated for specific input values. In some exemplary embodiments, a quantum circuit may be configured to process any input values of the input qubits. In some exemplary embodiments, during an execution stage, input values may be provided to the input qubits, and corresponding distributions may be created for the input qubits as part of a “set program”. For example, a set program may be configured to prepare (also referred to as ‘load’, ‘apply’, or ‘set’) initial quantum states on the input qubits. In some cases, a set program may comprise a function that receives as an input a pure quantum state on a set of qubits, or multiple pure quantum states, and outputs a quantum circuit that creates the pure quantum state(s) for those qubits. In some exemplary embodiments, after generating, or synthesizing, the set program, the set program may be added to the quantum circuit, such as by concatenating the set program to a beginning of the quantum circuit.

In some exemplary embodiments, an instantiated quantum program (also referred to as ‘instance’), which may comprise the set program as a prefix of the quantum circuit, may comprise an input-specific instance of the quantum circuit that executes the logic of the quantum circuit for the specific instances of the set program. In some exemplary embodiments, the instantiated quantum program may comprise an executable quantum circuit that may be executed on a quantum computer, simulated by a quantum simulator, or the like. In some exemplary embodiments, the instantiated quantum program may be designed to manipulate the quantum states of the input qubits, which correspond to the initial distributions that are created by the set program, and provide one or more output quantum states that comprise one or more distributions that result from manipulating the initial distributions.

In some exemplary embodiments, in order to measure the outputted distributions, the instantiated quantum program may be required to be executed multiple times, such as thousands of times. After each execution, the outputted distributions may be sampled, to thereby estimate the outputted distribution that is provided by the circuit. For example, in case an outputted distribution corresponds to a probability of ¾ to obtain a value of 1, and ¼ to obtain a value of 0, the instantiated quantum program may be executed multiple times, and ¾ of the executions may result with a sampled value of 1, while 4 of the executions may result with a sampled value of 0. In some cases, tomography methods may be used to distinguish between resulting distributions, such as in case that a plurality of distributions are represented by a probability of ¾ to obtain a value of 1, and a probability of ¼ to obtain a value of 0. Accumulating the different samples for a large number of executions (e.g., above a threshold) may enable to estimate the actual outputted distribution in a statistically significant manner.

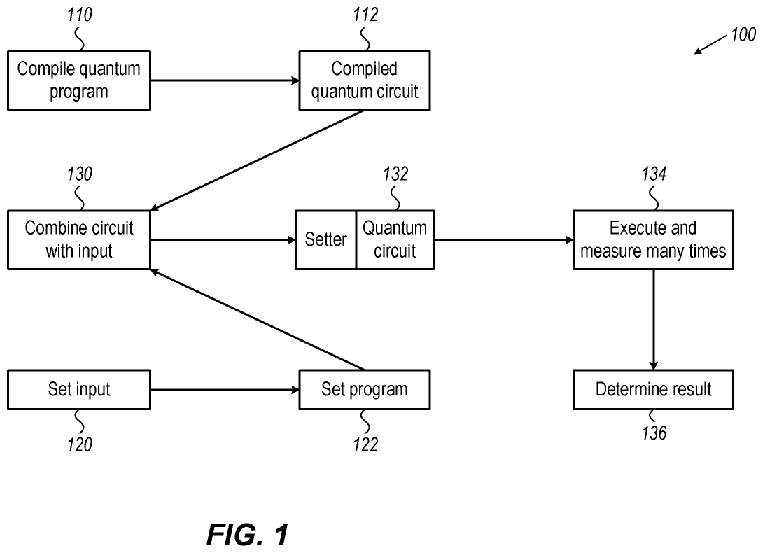

Referring now to FIG. 1, showing an exemplary instantiation process of a quantum program, in accordance with some exemplary embodiments of the disclosed subject matter. FIG. 1 depicts a Process 100 in which the user creates a quantum program that comprises various functions. In some exemplary embodiments, a high-level compiler may compile (110) the quantum program to generate a compiled quantum circuit (112), which implements the functions of the quantum program. For example, the quantum circuit may not be input-specific, and may not be instantiated.

During an execution phase, one or more input values for the initial quantum states of the qubits may be obtained (120). In some cases, the initial quantum states may be obtained from a user, obtained from another computer, generated randomly, or the like. For example, in case the quantum circuit implements a function that receives arguments, the values of the arguments of the function may correspond to initial quantum states of the circuit. In some exemplary embodiments, an initial quantum state may be associated with a qubit of the quantum circuit or a qubit register that includes one or more qubits (both referred to herein as a ‘qubit’). The compiler, or any other agent, may obtain the input values and generate, based thereon, a set program (122) that prepares the initial quantum states on the qubits.

In some exemplary embodiments, the compiler, or any other agent, may attempt to instantiate the quantum circuit for the input values (130), such as by combining the set program with the compiled quantum circuit (132). For example, the set program may be concatenated to the compiled quantum circuit. The resulting concatenated quantum circuit may comprise an input-specific instantiation of the quantum circuit. The created instance may be executed and measured multiple times (134), and after each execution, samples of the outputted distributions may be taken. Based on the measured samples, a statistically significant distribution of an output qubit may be determined (136).

In some exemplary embodiments, the plurality of executions of the instantiated quantum circuit may be deterministic, and may result with a same output. In some exemplary embodiments, every execution of the instantiated quantum circuit may utilize the same set program, and thus the same initial states. In some exemplary embodiments, it may be desired to enhance a resource utilization of the instantiated quantum circuit. In some scenarios, enhancing a resource utilization may comprise reducing the number of resources used to execute the instance, such as by reducing a quantity of gates, cycles, qubits, certain types of gates, or the like, without affecting a result of the execution.

In some exemplary embodiments, a naïve solution for reducing resources that are utilized for an execution of a quantum circuit, may comprise modifying the quantum circuit to remove therefrom redundant portions, such as two gates that inverse each other. For example, a representation of a quantum circuit may be analyzed, and a pattern that indicates that two gate cancel one another, may be identified and used to remove the gates from the quantum circuit.

The naïve solution may enhance a performance of the quantum circuit prior to an instantiation thereof, and thus the enhancement may be performed regardless of the set program, regardless of values that are set by the set program, or the like. However, the naïve solution may be suboptimal, or may have one or more drawbacks, at least since the enhancements that can be performed by the naïve solution are limited. In some cases, the enhancements that are allowed to be performed by the naïve solution may be required to comply with any potential input value at the instantiation stage, and cannot rely on a specific set of input values. For example, in case the naïve solution modified a portion of the circuit in a manner that complies with a first set of input values, but not with a second set of input values, the quantum circuit may not function properly when provided with the second set of input values, and thus the modification may not be proper, and may not be applied by the naïve solution. It may be desired to overcome such drawbacks, e.g., by removing such limitations.

Yet another technical problem dealt with by the disclosed subject matter is to enhance the resource utilization of input-specific instances of a quantum circuit. For example, it may be desired to apply modifications that do not damage an execution of an input-specific instance, and reduce a number of resources that are used by such executions. For example, this may be useful for the process of measuring the result of the instance, which may require a large number of executions of the same instance. It may be challenging to modify instances of quantum circuits, at least since such instances are already compiled, and their qubit values may not be known.

One technical solution provided by the disclosed subject matter comprises modifying a quantum circuit for specific input values, based on a simulation of the quantum circuit or portion thereof. In some exemplary embodiments, the term ‘qubit’, as used herein, may refer to one individual qubit, or to a qubit register (e.g., a group of qubits).

In some exemplary embodiments, quantum state data may be obtained from a simulation. In some exemplary embodiments, quantum state data may comprise values of quantum states of qubits, metadata associated with purity sets of qubits, other properties associated with quantum states of qubits, a combination thereof, or the like. In some exemplary embodiments, the quantum state data may be associated with one or more quantum states of qubits, and may be determined based on a simulation of a portion of a quantum circuit. For example, a simulator may be executed on a portion of a quantum circuit, such as a compiled portion thereof, in order to measure the quantum state data of the portion of the quantum circuit. As another example, a simulator may be executed on a portion of a quantum circuit, in order to measure quantum states of qubits, and the quantum state data may be determined based on the measured states.

In some exemplary embodiments, a partial or full compilation of the quantum circuit may be performed, in order to enable a simulator to simulate at least the portion of the quantum circuit (a ‘compiled portion’). In some cases, the compiled portion of the quantum circuit may be obtained by compiling a first subcircuit of the quantum circuit, and not compiling a second subcircuit of the quantum circuit. In some exemplary embodiments, the second subcircuit may be determined not to be compiled based on an estimation that a simulation of both the first and second subcircuits is not feasible, such as due to an estimation that a simulator that is configured to perform the simulation will run out of resources, such as time, memory, computation power, or the like, and will not be able to complete the simulation. In some cases, performing the simulation may be infeasible with a given set of resources in view of the state-explosion problem, or a similar issue relating to the complexity of what is being simulated. In other cases, an entirety of the quantum circuit may be compiled, to thereby obtain a compiled quantum circuit. In such cases, the compiled portion that is simulated by the simulator may comprise at least a portion of the compiled quantum circuit.

In some exemplary embodiments, after compilation, a simulation of the compiled portion of the quantum circuit may be performed, in order to identify quantum state data thereof. For example, the portion of the quantum circuit that is simulated by the simulator, may be configured to prepare one or more input values on one or more input qubits of the quantum circuit. In some exemplary embodiments, the portion of the quantum circuit may be configured to produce an output value of an output state, such as based on the one or more input values. In some exemplary embodiments, the portion of the quantum circuit may produce the output value based on a manipulation of the one or more input qubits when having the one or more input values. The simulation may be configured to measure the one or more input values, the output value, or the like, and retain them as part of the quantum state data. For example, the input values may be retained by the simulator in association with respective qubit identifiers, respective cycles, or the like, during which the input values are measured.

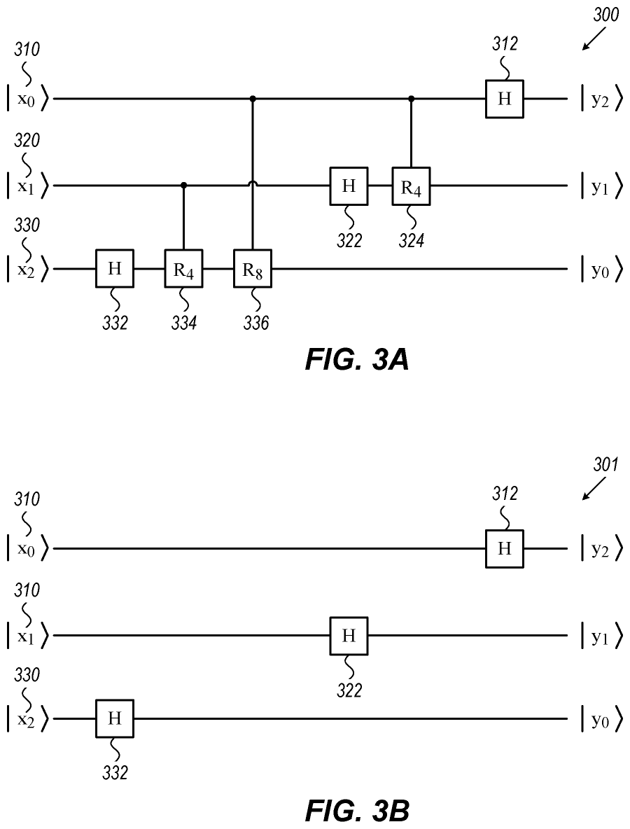

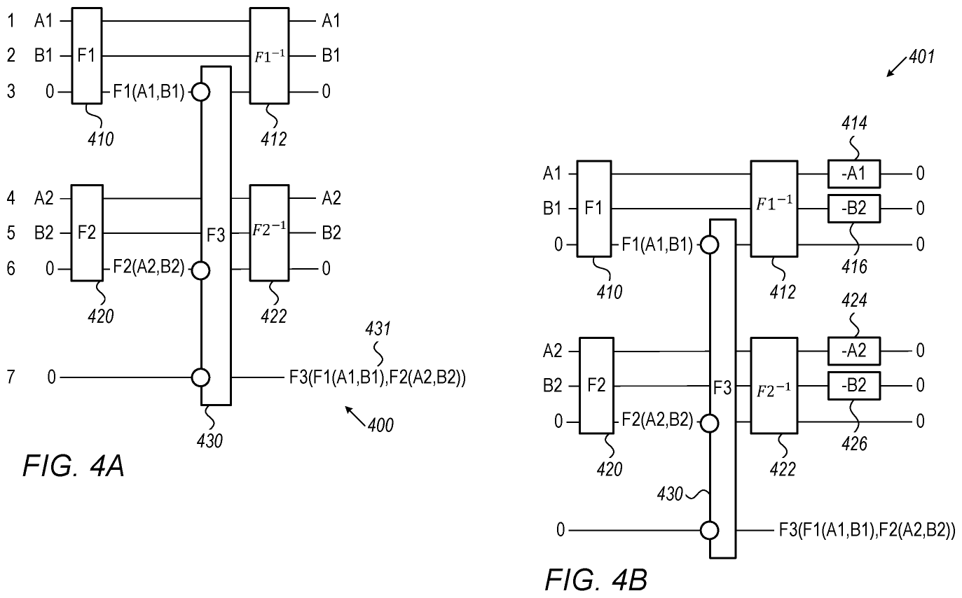

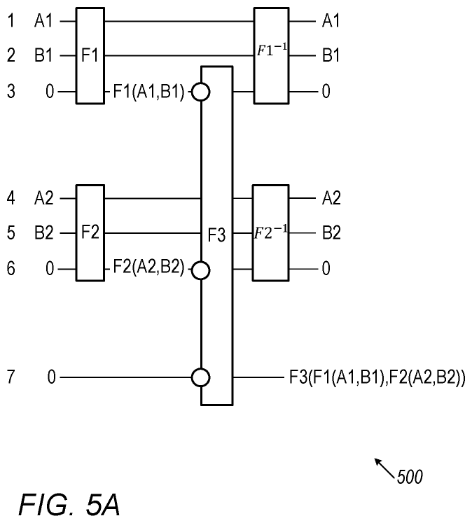

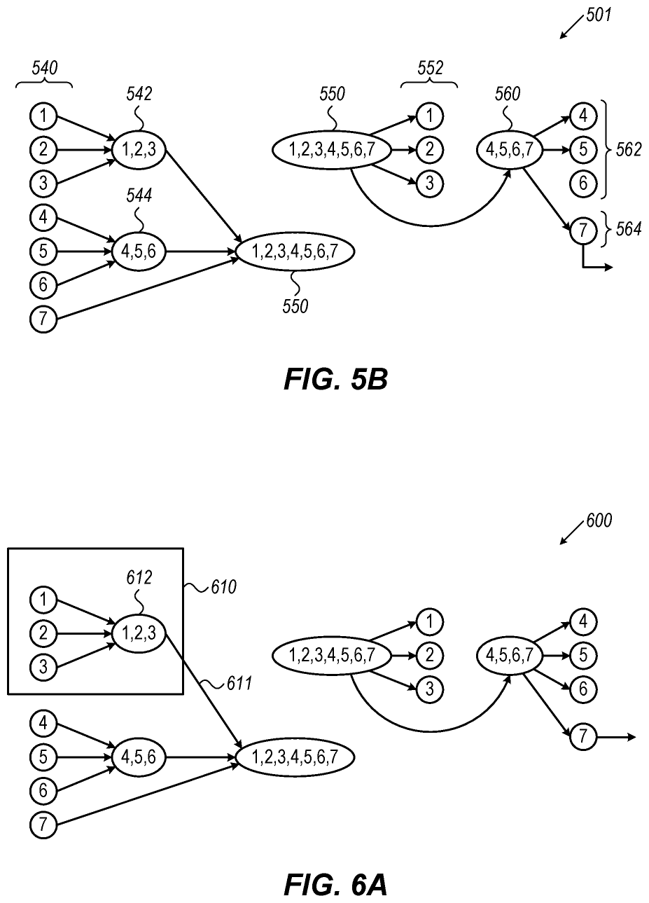

In some exemplary embodiments, based on the quantum state data, one or more modifications of the quantum circuit may be determined to be performed. In some exemplary embodiments, determined modifications to a quantum circuit may comprise removing redundant gates (e.g., as depicted in FIG. 3B), replacing two-qubit gates with one-qubit gates, reusing qubits for subsequent or concatenated quantum programs (e.g., as depicted in FIG. 4C), replacing selected subcircuits of a quantum circuit with a set program (e.g., as depicted in FIGS. 6A-6B and 7), or any other modification.

For example, a quantum gate may be determined to be redundant for preparing the output value, based on the quantum state data. According to this example, the quantum gate may not be redundant for all potential input values of the quantum circuit, but only with respect to the specific input values, and thus may be determined to be removed. As another example, in case that the quantum circuit is set with the input values on the input qubits, a two-qubit quantum gate of the quantum circuit may be determined to be replaceable with a one-qubit quantum gate, e.g., without affecting the output value. As another example, in case that the quantum circuit is set with the input values on the input qubits, a qubit of the quantum circuit may be determined to be reusable. As another example, in case that the quantum circuit is set with the input values on the input qubits, a subcircuit of the quantum circuit may be determined to be replaceable with a set program, e.g., without affecting the output value. According to this example, the subcircuit may be determined to be replaceable with a set program based on an identification that the subcircuit does not divide any purity sets of qubits, e.g., as indicated by the quantum state data.

In some exemplary embodiments, the modification of the quantum circuit may be configured to reduce a resource utilization of the quantum circuit, such as a utilization of a qubit resource, a cycle resource, a quantum gate resource, or the like, when the quantum circuit is set with the input values on the input qubits. For example, the modifications may be determined to be performed in case the modifications are estimated to increase an efficiency of an execution of the quantum circuit. In some cases, an efficiency of an execution may relate to a number of resources used by the execution, such as a number of gates, qubits, cycles, types of gates, weights thereof, or the like. In some exemplary embodiments, the modification of the quantum circuit may be configured to result with a same output as the quantum circuit, e.g., a same distribution, error rate, or the like, as the quantum circuit.

In some exemplary embodiments, based on determining one or more modifications to the quantum circuit, a modified quantum circuit may be generated. In some exemplary embodiments, the modified quantum circuit may incorporate the determined modifications to the quantum circuit. In some exemplary embodiments, the modified quantum circuit may be configured to produce a same distribution, error rate, or the like, as the original quantum circuit. For example, in some cases, the output value that is produced by the portion of the original quantum circuit, may be produced also by the modified quantum circuit.

In some exemplary embodiments, the modified quantum circuit may be generated to implement one or more determined modifications to the quantum circuit. For example, in case a quantum gate of the quantum circuit is determined to be redundant based on the quantum state data, the modified quantum circuit may be generated by removing the quantum gate from the quantum circuit. As another example, in case a two-qubit quantum gate of the quantum circuit is determined to be replaceable with a one-qubit quantum gate based on the quantum state data, the modified quantum circuit may be generated by replacing the two-qubit quantum gate with the one-qubit quantum gate. As another example, in case a qubit is determined to be reusable based on a measured quantum state value of the qubit of the quantum circuit, as measured by the simulation, the modified quantum circuit may be generated by applying an inverse state that is an inverse of the quantum state value on the qubit. For example, in case the measured quantum state value of a qubit is {⅓, ⅔}, indicating that the state has a probability of ⅓ to obtain a value of 1, and a probability of ⅔ to obtain a value of 0, the modified quantum circuit may be generated by applying to the qubit an inverse state, of {−⅓, −⅔}, such as in order to initialize the qubit to ground state, and enable other processes to make use of the qubit. As another example, in case a subcircuit of the quantum circuit is determined to be replaceable with a set program, the modified quantum circuit may be generated by replacing the subcircuit with the set program. For example, in case the subcircuit is configured to output a certain quantum state (e.g., the output value), the set program may be configured to comprise a quantum state setter that prepares the same output value.

In some exemplary embodiments, after modifying the quantum circuit, the modified circuit may be recompiled, such as in order to enable the compiler to make use of any released resources. In some exemplary embodiments, recompiling the modified quantum circuit may comprise recompiling the compiled portion of the quantum circuit, or recompiling the entire circuit.

For example, the quantum circuit may comprise a first subcircuit and a second subcircuit, and the portion of the quantum circuit may correspond to the first subcircuit. In some exemplary embodiments, the first subcircuit may be compiled, thereby obtaining a compiled portion, over which the simulator may be executed. Subsequently, a compilation process of the quantum circuit may be paused, or terminated, without compiling the second subcircuit. The modified quantum circuit may be generated by modifying the first subcircuit to a modified first subcircuit, and the modified first subcircuit may be recompiled. After recompiling the modified first subcircuit, the compiler may continue the compilation process to compile the second subcircuit, whereby the second subcircuit is only compiled once. In other cases, any other compilation scheme may be performed. For example, the entire quantum circuit may be compiled, and after the modifications to the first subcircuit, the modified quantum circuit may be compiled.

In some exemplary embodiments, the modified quantum circuit, a compiled version thereof, or the like, may be executed on a quantum computer. In some exemplary embodiments, the modified quantum circuit may be executed on the quantum computer multiple times, such as in order to measure an output of the modified quantum circuit. For example, a resulting distribution of the modified quantum circuit may be sampled after each execution, and used to approximate the value of the resulting distribution. In some cases, the output of the modified quantum circuit may be identical to the output of the original quantum circuit, and thus the modification of the quantum circuit may not affect the outputted distribution of the quantum circuit, or its error rate.

One technical effect obtained by the disclosed subject matter is enabling to reduce resources that are used for executing an instantiated quantum circuit. In some exemplary embodiments, executing a modified instance of the quantum circuit may be resource conserving compared to executing the original instance of the quantum circuit.

Another technical effect obtained by the disclosed subject matter is reducing a number of resources that are used for executing an instance of a quantum circuit, while ensuring that the functionality of the circuit is maintained. In some cases, in case the output of the modified quantum circuit is identical to the output of the original quantum circuit, the modification of the quantum circuit may be determined not to affect the output of the quantum circuit, and thus the functionality of the quantum circuit may be considered to be maintained. In other cases, in case the output is within a threshold error to the original output value, the functionality may be considered as maintained.

Yet another technical effect obtained by the disclosed subject matter is enhancing a measurement process of a quantum circuit, by removing redundant portions for an input-specific instance of the quantum circuit. The redundant portions may be identified based on a simulation that identified values of qubit states. The disclosed subject matter may provide for one or more technical improvements over any pre-existing technique and any technique that has previously become routine or conventional in the art. Additional technical problem, solution and effects may be apparent to a person of ordinary skill in the art in view of the present disclosure.

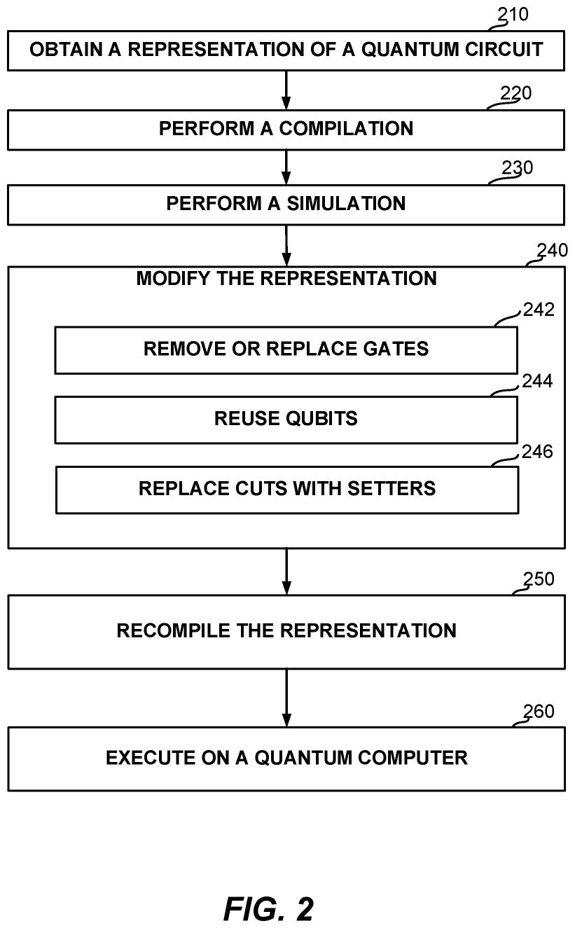

Referring now to FIG. 2, depicting an exemplary flowchart diagram of a method, in accordance with some exemplary embodiments of the disclosed subject matter.

On Step 210, a representation of a quantum circuit may be obtained. In some exemplary embodiments, the representation may comprise a gate-level representation of the circuit, a functional-level representation of the circuit, or the like. In some exemplary embodiments, the representation may be obtained from a compiler, from a server, from a user interface, or the like. For example, the representation of the quantum circuit may be generated by a compiler, based on a quantum program that is programmed by a quantum programmer. The quantum circuit may also be referred to as the ‘original quantum circuit’.

In some exemplary embodiments, the representation of the circuit may comprise a mapping of functional blocks or segments, such as in a form of a Directed Acyclic Graph (DAG). In other cases, the representation may comprise any other representation of the quantum circuit in a functional level, in a gate level, or the like. For example, a DAG may comprise a representation of the quantum circuit, in which the nodes represent portions of the quantum circuit, and the edges between the nodes indicate a precedence relationship between the portions. In some cases, the edges of the DAG may indicate an output-input relationship between the two connected portions of the quantum circuit, such defining that an output of a first node is used as an input of a second node. In some cases, the DAG may not represent an instantiated circuit, but rather a non-compiled representation of the quantum circuit.

In some exemplary embodiments, the quantum circuit may comprise a set program that sets one or more initial quantum states to input qubits. In some exemplary embodiments, in order to measure a result of the quantum circuit, the quantum circuit must be executed multiple times with the same set program. Since the quantum program may be deterministic, such executions may be identical executions, and may be performed solely for obtaining multiple samples of the outputted distribution(s). In some cases, instead of performing such executions using the original quantum circuit, the executions may be performed on a modified quantum circuit that is enhanced prior to performing the measurement, e.g., according to Steps 220-250.

On Step 220, at least a portion of the quantum circuit may be compiled, to thereby obtain a compiled quantum circuit, a partially compiled quantum circuit, or the like, which may be all referred to herein as a ‘compiled subcircuit’. For example, a partial compilation may be performed for one or more selected portions of the circuit that are expected to be successfully simulated by a determined simulator, e.g., without the simulator terminating prematurely, such as by exhausting its available resources or facing the state-explosion problem.

An estimation of how far a simulation may be able to run before the simulator exhausting its respective resources, may be used for selecting a circuit portions for the optimization, and these circuit portions may be compiled. As another example, a partial compilation may be performed until a defined limit, such as one or more defined cycles for each qubit, one or more defined nodes of the quantum circuit, until reaching one or more subcircuits of the quantum circuit, or the like. In some cases, the defined limit may be defined based on an estimation of when a simulator that will potentially be executed on the compiled quantum circuit, will exhaust its resources, or based on any other estimation. For example, the location of the simulator's failure may relate to an estimated cycle-wise location, an estimated subcircuit that is estimated to cause the simulator to encounter an exploded state-space, or the like. In some cases, a machine learning predictor may be trained, over a training dataset that comprises previous exploded or failed simulations of various circuits, to estimate a defined limit for the compilation. In other cases, an estimation of a defined limit may not be performed, and instead the compiler and simulator may be executed in an interleaved manner, such as by compiling one or more first portions of the circuit, executing the simulator over the compiled first portions, compiling one or more subsequent portions of the circuit, executing the simulator over the compiled subsequent portions, and the like, until the simulator exhausts its resources and the simulation faces the state-space explosion problem.

In other cases, the entire quantum circuit may be compiled, resulting with the compiled subcircuit. In such cases, the compiled subcircuit may comprise a compiled version of the entire quantum circuit.

On Step 230, at least a portion of the compiled subcircuit may be simulated. In some exemplary embodiments, the simulation may be performed by one or more simulators that are executed by a classical computer, a quantum computer, a combination thereof, or the like. For example, the simulation may be performed by a quantum simulator, a classical simulator, or the like. In some cases, the simulator may be configured to simulate the compiled DAG, the compiled subcircuit, or the like.

In some cases, quantum circuits may not be fully simulatable, such as in case the circuits are too complex to be represented by a simulator over all of the defined cycles, thus causing the simulator to fail immediately, or to terminate prematurely after simulating the circuit over a number of cycles. In some exemplary embodiments, a circuit may be considered not fully simulatable in case it cannot be executed fully by a simulator, but can rather be executed up to a certain cycle. For example, a circuit that comprises multiple entangled qubits may be more complex than a circuit that does not comprise multiple entangled qubits, which may result with a state-space explosion of the simulation after a limited number of cycles. In some exemplary embodiments, in case that a circuit is not fully simulatable, one or more simulators may perform a partial simulation by simulating the circuit over a limited number of cycles, such as over the compiled subcircuit, over a portion of the compiled subcircuit, or the like.

In some exemplary embodiments, prior to exploding, the states of the qubits over one or more cycles, including quantum state data such as their values, their purity statuses, or the like, may be determined by the simulator. In some exemplary embodiments, as long as a portion of the compiled subcircuit can be simulated, properties of the quantum states in the subcircuit may be determined. For example, during the simulated cycles, the simulation may enable to determine quantum state data such as an entanglement status of the qubit states, states of qubits in each simulated cycle, a purity group to which each qubit belongs, one or more initial quantum states, a state of the same qubit at different cycles, or the like. In some exemplary embodiments, the simulated qubit states may be followed, tracked, or the like, by the simulator, for as many cycles as possible within the compiled subcircuit.

In some exemplary embodiments, simulators may be enabled to identify exact, or actual, quantum states of qubits in the quantum circuit, that are not merely estimates of the states (e.g., in contrast to samples of quantum circuit executions, which may be performed by tomography and may be used to estimate a state of an output). In some exemplary embodiments, when and if the simulation fails, the retrieved quantum states properties, or data, may be used to simplify the circuit, to reduce the size of the circuit, or the like, e.g., according to Step 240. In some exemplary embodiments, a simulation may be executed once in order to determine the quantum state data, in contrast to classical computer, which may be required to be executed multiple times, such as in order to add randomness to the results (e.g., since classical simulations may not be deterministic).

In some exemplary embodiments, the compilation and simulation may be interleaved, or may be partially or fully performed in one or more defined orders. For example, a partial compilation may be performed by compiling a first subcircuit of the quantum circuit, the compiler may be paused, and a simulation may be executed over the compiled first subcircuit, after which the compiler may continue to compile the remaining quantum circuit.

On Step 240, the representation of the quantum circuit may be modified, e.g., based on the quantum state data. For example, the modifications may be performed based on identified values of quantum states of the qubits, as identified by one or more simulators. As another example, the modifications may be performed based on identified purity groups of the qubits, as identified by one or more simulators.

In some exemplary embodiments, the quantum circuit may be modified, in order to reduce resources that are used by executing the quantum circuit multiple times. For example, modifying the quantum circuit may comprise simplifying the circuit by removing gates therefrom, replacing complex gates (e.g., two-qubit gates) with simple gates (e.g., one-qubit gates), enabling to reuse qubits between function instances, or the like. In some exemplary embodiments, a decision regarding which modifications should be performed, may be made based on the simulated values of the quantum states, or based on any other quantum state data. For example, one or more subcircuits may be determined to be removed or replaced, one or more elements a subcircuit may be determined to be removed or replaced, or the like.

In some exemplary embodiments, modifying the quantum circuit may comprise modifying the representation of the quantum circuit, by generating a representation of a new quantum circuit based on the representation of the original quantum circuit, or the like.

On Step 242, the quantum circuit may be modified by removing or replacing quantum gates thereof. For example, this may be performed based on identifying quantum state values of one or zero. In some cases, in case a control qubit is identified by the simulation to have a zero state when associated with a gate, the gate may be removed from the quantum circuit. For example, a control qubit may be identified by the simulation to stay in a zero state when connected to one or more quantum, and thus the gates may be determined to be redundant. In such cases, the quantum circuit may be modified to remove the redundant gates, thereby causing future instantiations of the quantum circuit to utilize less gates compared to instantiations of the original quantum circuit. It is noted, in this regard, that the gates that are removed in this scenario may be redundant only in the view of the specific state of the control qubit, and for other states of the control qubit, removing the gates may damage the performance of the circuit. Thus, the modification may be input-specific.

In some cases, in case a control qubit is identified by the simulation to have a state of one when associated with a gate, e.g., a two-qubit gate, the gate may be updated, such as by replacing the gate with a one-qubit gate, a setter of a value of one, or the like. For example, a determination that a two-qubit quantum gate that is attached to first and second qubits can be replaced with a one-qubit quantum gate, may be performed in case that, when the quantum circuit is set with a set of input values on the input qubits, as determined by the simulator, the two-qubit quantum gate manipulates only the first qubit. In such cases, the one-qubit quantum gate may be generated to replace the two-qubit gate, and may be attached only to the first qubit and not to the second qubit (e.g., as the second qubit was not manipulated by the two-qubit gate).

In some exemplary embodiments, a modification to a quantum circuit may be considered to enhance the circuit, in case it reduces a number of resources used by the circuit, reduces a complexity of the resources used by the circuit, or the like. For example, reducing the number of resources may refer to reducing a number of cycles of the circuit (e.g., making the circuit faster), reducing a number of other time units that are associated with the circuit (e.g., an execution time), reducing a number of qubits, reducing a number of gates, a combination thereof, or the like. In some cases, based on such parameters, a calibration may be performed, producing an overall ‘resource score’ for a circuit execution. For example, the resource score may be determined based on a weighted objective function (e.g., provided by a user), heuristics, a defined rule for combining the different resource parameters to a single score, or the like. In some exemplary embodiments, a modification to a quantum circuit may not be considered to enhance the circuit, in case it changes a resulting distribution of a circuit, increases an error rate of the result, increases an error rate of the result above a threshold, or the like.

In some exemplary embodiments, a decision regarding which gates should be removed or replaced, may be made based on the simulated values of the quantum states. In some exemplary embodiments, the quantum circuit may be modified by removing therefrom transform gates, replacing gates, or the like, e.g., as depicted in FIG. 3B.

Referring now to FIGS. 3A-3B, showing an exemplary modification of a quantum circuit, in accordance with some exemplary embodiments of the disclosed subject matter.

In some exemplary embodiments, FIG. 3A may depict a Quantum Circuit 300 that is configured in a general manner, for non-specific inputs. In some exemplary embodiments, Quantum Circuit 300 may be created by a user, obtained from a third party, or the like. Quantum Circuit 300 may comprise Input Qubits 310, 320, and 330 (denoted X0, X1, and X2), which may be configured to be manipulated over a plurality of gates.

In some exemplary embodiments, Quantum Circuit 300 may be modified for a specific set of input values, thereby obtaining Quantum Circuit 301 of FIG. 3B. In some exemplary embodiments, in order to modify Quantum Circuit 300, at least a portion thereof may be compiled and simulated, to determine one or more states thereof. For example, a simulation of Quantum Circuit 300 may find that Input Qubits 310 and 320 comprise a zero state, or ground state, throughout the circuit. According to this example, all the conditional gates (Gates 324, 334, and 336) may be removed from Quantum Circuit 300, and only the H gates (Gates 312, 322, and 332) may be retained, thus producing Quantum Circuit 301. Gates 324, 334, and 336 may be removed at least since the zero states of Input Qubits 310 and 320 may constitute the control states of Gates 324, 334, and 336.

In some exemplary embodiments, Quantum Circuit 301 may comprise an input-specific circuit representation, that may only function properly for the described input set. For example, in case that Input Qubits 310 and 320 would have a non-zero state, removing Gates 324, 334, and 336 will corrupt the result of the circuit execution. In some exemplary embodiments, Quantum Circuit 301 may utilize less resources than Quantum Circuit 300, at least since Gates 324, 334, and 336 may be excluded from Quantum Circuit 301. In some cases, after generating Quantum Circuit 301, Quantum Circuit 301 may be re-compiled.

In some exemplary embodiments, Quantum Circuit 300 may be modified for any other quantum states of Input Qubits 310, 320, and 330. As an example, in case that Input Qubit 310 has a value of zero, Input Qubit 320 has a value of one, and Input Qubit 330 has a known (pure) state, then the qubit gates for which Input Qubit 310 constitutes a control qubit (Gates 324 and 336) may be removed, while the two-qubit gate for which Input Qubit 320 constitutes a control qubit (Gate 334) may be turned into a one-qubit gate, thereby modifying Quantum Circuit 300 to a simplified input-specific circuit. In other cases, Quantum Circuit 300 may be modified according to any other input values.

Referring back to FIG. 2, on Step 244, the quantum circuit may be modified to enable a reuse of qubits. In some cases, quantum circuits may be modified without necessarily removing gates, such as by enabling to reduce a number of qubits. For example, as depicted in FIGS. 4A-4C, a quantum circuit may be modified to enable to reuse input qubits, e.g., based on a specific set of values of the qubit states. In some exemplary embodiments, a decision regarding which qubits should be reused, may be made based on the simulated values of the quantum states.

Referring now to FIGS. 4A-4C, showing exemplary modifications of a quantum circuit that enable to reuse qubits, in accordance with some exemplary embodiments of the disclosed subject matter.

In some exemplary embodiments, FIG. 4A depict a quantum circuit, e.g., Quantum Circuit 400, that is not input-specific. For example, Quantum Circuit 400 may be configured to multiply quantum states of four input qubits: denoted A1, A2, B1, B2. Quantum Circuit 400 may comprise seven qubits: four input qubits (qubits 1, 2, 4, and 5), two auxiliary qubits (qubits 3 and 6), and one output qubit (qubit 7). In some exemplary embodiments, Quantum Circuit 400 may be configured to receive input values for input qubits A1, A2, B1, B2, and return a multiplication of the values. For example, when receiving the input values X Y, Z and W, Quantum Circuit 400 may be compiled, such as according to Step 132 of FIG. 1, to an input-specific instantiation that outputs a value of X*Y*Z*W. The instantiation of the circuit may be performed after the input is provided, and thus Quantum Circuit 400 may be used for any obtained input values.

At a first stage, qubits 1-3 (denoted A1, B1, and auxiliary qubit ‘0’) are manipulated by Function 410 (denoted ‘F1’). For example, Function 410 may multiply A1 with B1, and store the product in the auxiliary qubit. Simultaneously, qubits 4-6 are manipulated by Function 420 (denoted ‘F2’). For example, Function 420 may multiply A2 with B2, and store the product in the auxiliary qubit. In some exemplary embodiments, output qubits from both Functions 410 and 420, including the product of the previous multiplications, are provided to Function 430 (denoted ‘F3’), together with the output qubit of the function (e.g., qubit seven). Function 430 may multiply the product from Function 410 with the product from Function 420, thus obtaining a product of A1, A2, B1, and B2. Qubits 1-3 that exit Function 430 are then inversed, by an Inverse Function 412 (denoted ‘F1⁻¹’) that comprises an inverse matrix of Function 410, while qubits 4-6 that exit Function 430 are inversed by an Inverse Function 422 (denoted ‘F2⁻¹’) that comprises an inverse matrix of Function 420. An Output Qubit 431 of Function 430 provides the product of A1, A2, B1, and B2 via qubit number seven.

In some exemplary embodiments, Quantum Circuit 400 may be optimized for a specific set of state values {X Y, Z, W}, such as the set of values {1, 1 3, 2 5, 0}. For example, FIG. 4B may depict a Quantum Circuit 401 that is a result of modifying Quantum Circuit 400 to be input specific. In some exemplary embodiments, the known state values X Y, Z, W, may be used to configure Quantum Circuit 401 to inverse values X Y, Z, W at an end of the circuit. For example, Quantum Circuit 401 may comprise Inverse Functions 414, 416, 424, and 426 for inversing the specific set of values of the input qubits, thus initializing the values of the qubit states and enabling to reuse the input qubits for any subsequent function, in a manner that would not be possible without knowing the exact values of the input qubits.

In some exemplary embodiments, releasing qubits at an end of Quantum Circuit 401 may be useful in many scenarios, such as in case Quantum Circuit 401 is implemented more than once, e.g., as depicted in FIG. 4C.

FIG. 4C depicts an exemplary scenario in which the input qubits are reused. In some exemplary embodiments, the input qubits may be reused, such as in case that the functionality of Quantum Circuit 401 is implemented twice, one after each other, such as in order to multiply eight input qubits with one another, instead of multiplying four input qubits, as performed in Quantum Circuit 401. In some exemplary embodiments, a naïve method of multiplying eight input qubits may require at least 15 qubits, including eight input qubits and seven auxiliary qubits. However, reusing the input qubits may enable to multiply values of eight input qubits, while only adding a single additional qubit: Output Qubit 440, as depicted in FIG. 4C.

For example, FIG. 4C depict Quantum Circuit 402, which enables to multiply eight input qubits using only nine qubits, without adding any additional input qubit beyond the input qubits of Quantum Circuit 401. Quantum Circuit 402 includes a first portion, that corresponds to Quantum Circuit 401, resulting with a product of A1, B1, A2, and B2, and then reuses the input qubits at Stage 450, by setting each input qubit with a state of the remaining four values of input qubits: the values of A3, B3, A4, and B4. These values are then multiplied, using the same functions as Quantum Circuit 401 (e.g., denoted F4-F6, which correspond to F1-F3, respectively). The products of both multiplications are multiplied with each other at Function 460 (denoted ‘F7’), and provided as a result through Output Qubit 440. The functions are then inversed, using Inverse Function 462 (denoted ‘F6⁻¹’, the inverse of F6) and 464 (denoted ‘F3⁻¹’, the inverse of F3).

In some exemplary embodiments, in other scenario, Quantum Circuit 401 may be implemented any other number of times, while reusing the input qubits. For example, in case Quantum Circuit 401 is used four times, in order to multiply sixteen input qubits with each other, the resulting circuit may concatenate Quantum Circuit 401 four times, or concatenate Quantum Circuit 402 twice. In such cases, two additional qubits may be used, in addition to the qubits of Quantum Circuit 402: one additional qubit may be used for retaining a result of a second instance of Quantum Circuit 402, and one additional qubit may be used for combining the results of the first and second instances of Quantum Circuit 402.

Referring back to FIG. 2, on Step 246, the quantum circuit may be modified by replacing subcircuits of the quantum circuit, with quantum state setters, based on purity sets of the qubits. In some exemplary embodiments, during simulation, the simulator may track which qubits or qubit registers are pure (e.g., not entangled with other qubits). For example, a pure decomposition graph (e.g., represented as a DAG) may be generated based on the simulation, and may indicate, for each stage of the simulation, which qubits of the quantum circuit belong to which purity sets. In some exemplary embodiments, the tracking may include tracking purity sets of qubits, where each purity set indicates that its members are pure with respect to the external qubits, but may be entangled with each other. For example, first and second qubits (e.g., individual qubits or qubit registers) may belong to a same purity set even if they are entangled with each other, as long as they are not entangled with any other qubit of the quantum circuit. In some exemplary embodiments, in case the simulation indicates that a qubit state of a set of one or more qubits is pure, the qubits may be replaced with a quantum state setter.

In some exemplary embodiments, quantum state setters (referred to herein as ‘setters’) may be generated and used to set, or apply, one or more types of states, or quantum information, to respective qubits. In some exemplary embodiments, setters may be configured in a set program to receive as an input one or more pure quantum states for a set of qubits, and to create the pure quantum state(s) for those qubits. In some exemplary embodiments, a setter may be attached, wired, or otherwise associated with an individual qubit, a group of qubits such as a quantum register, or the like. For example, a quantum state setter may be disclosed in U.S. patent application Ser. No. 17/752,282, tiled “Auxiliary Qubit Verification In Quantum Circuits”, filed May 24, 2022, which is hereby incorporated by reference in its entirety without giving rise to disavowment.

In some exemplary embodiments, setters may be used to replace one or more pure sets of qubits, or any portion of the quantum circuit that is not entangled with the remaining portions of the circuit. For example, in case a portion of the quantum circuit is not entangled with the remaining portions of the circuit, and is configured to create one or more quantum state distributions (e.g., as a result of the portion), the portion may be replaced with a setter that creates the same quantum state distributions directly. In some cases, replacing a subcircuit that results with a distribution, with a setter that prepares the distribution directly, may release one or more qubit resources. It is noted that a cost, in resource units, of creating a distribution directly with a setter, may not be greater than a cost of the subcircuit that creates the distribution.

In some exemplary embodiments, modifications may be enabled to be performed with respect to pure qubits, pure groups of qubits, or the like, such as by replacing a pure qubit with a setter, replacing a pure portion with a setter, or the like. In some exemplary embodiments, modifications may not be performed for an entangled portion of the circuit. For example, a first portion of a circuit that is entangled with a second portion of the circuit may not be modified separately from the second portion, at least since that may affect the second portion of the circuit in undesirable ways.

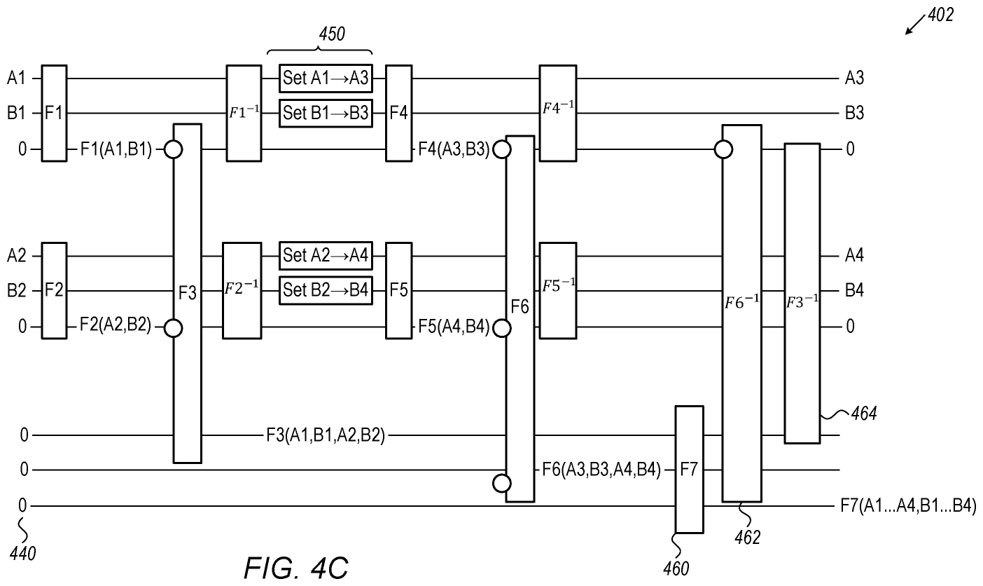

In some exemplary embodiments, in order to replace a portion of the circuit with a setter, the portion may be selected to be modified based on one or more calculations. In some cases, selecting a portion to be replaced may be computationally challenging, since there may be an exponential number of potential selections of subcircuits. In some exemplary embodiments, each portion that is selected to be modified may be referred to as a “selected subcircuit”, while a new replacement for the portion may be referred to as a “replacement set program”. In some exemplary embodiments, a selected subcircuit may be selected based on a pure decomposition graph that represents the circuit, e.g., as disclosed in FIGS. 5A-5B.

In some exemplary embodiments, the distributions of a set of qubits may be known to a simulator, and the simulator may be configured to utilize the known distributions in order to designate sets of qubits that are pure, such as via a pure decomposition graph. In some exemplary embodiments, a pure decomposition graph may be generated by the simulator or the compiler based on the quantum program, such as based on a simulation of the compiled subcircuit. In some exemplary embodiments, a pure decomposition graph may comprise a graph representing a quantum circuit, a high level description of the quantum circuit, or the like. In some exemplary embodiments, a pure decomposition graph may comprise edges that correspond to pure sets of qubits, and nodes that correspond to manipulations of the qubits by one or more gates of the quantum circuit over one or more cycles. For example, an edge of a pure decomposition graph may be marked with a qubit register that is pure with respect to any external qubit, but may be entangled within the qubit register, e.g., in case the qubit register comprises qubits that are entangled with one another. As another example, an edge of a pure decomposition graph may be marked with an individual qubit that is in a pure state.

Referring now to FIGS. 5A-5B, showing an exemplary pure decomposition graph, in accordance with some exemplary embodiments of the disclosed subject matter.

In some exemplary embodiments, FIG. 5A may correspond to FIG. 4A. For example, FIG. 5A may depict a Quantum Circuit 500 that corresponds to Quantum Circuit 400 of FIG. 4A. FIG. 5B may depict a Pure Decomposition Graph 501 that is generated for Quantum Circuit 500 based on a simulation of Quantum Circuit 500.

In some exemplary embodiments, Pure Decomposition Graph 501 may be constructed as a graph, such as a DAG, that indicates, for each stage of the simulation of Quantum Circuit 500, which qubits are pure, in groups or individually. For example, a pure group may comprise qubits that are entangled with each other, but not with qubits that are external to the pure group.

In some exemplary embodiments, a beginning of the simulation of Quantum Circuit 500, all the qubits may be individual pure qubits, and then may become pure in qubit registers, or groups of qubits, until being released. As depicted in FIG. 5B, at Stage 540, all seven qubits form separate purity sets. After Functions 410 and 420 (FIG. 4A) manipulate qubits 1-3 and 4-6, respectively, these qubits form two respective purity set, e.g., Purity Sets 542 and 544. In some exemplary embodiments, the qubits may be subsequently manipulated by Function 430 (FIG. 4A), together with qubit 7, thus forming a single purity set that comprises all of qubits 1-7, e.g., Purity Set 550.

In some exemplary embodiments, Purity Set 550 may be dismantled by applying inverse functions on the qubits 1-6, which separates them to respective purity sets. Specifically, a first inverse function is applied at Stage 552 to qubits 1-3, thereby creating separate purity sets for each of qubits 1-3, and retaining a single purity set for qubits 4-7, e.g., Purity Set 560. In some exemplary embodiments, a second inverse function is applied to qubits 4-6 of Purity Set 560, thereby creating separate purity sets for each of qubits 4-6 at Stage 562, and retaining a single purity set for qubit 7, which constitutes the output qubit, e.g., Purity Set 564. In some exemplary embodiments, at an end of Pure Decomposition Graph 501, all the qubits are released and constitute separate purity sets.

In some exemplary embodiments, a selection of one or more selected subcircuits in Quantum Circuit 500, may be determined by selecting which portion of Pure Decomposition Graph 501 should be “cut” out of the graph. For example, this may ensure that entangled portions are not modified. In some exemplary embodiments, applying a “cut” on Pure Decomposition Graph 501, also referred to as a minimal cut, may comprise a cut of the edges of Pure Decomposition Graph 501, without splitting any node of Pure Decomposition Graph 501, that creates a connected graph in the undirected underlying graph, and cuts it away from the rest of the graph. In some exemplary embodiments, selecting a cut may comprise deciding where, among the exponential number of options, to replace the existing subcircuits with a set program. In some cases, selecting a cut may be computationally challenging, since there may be an exponential number of cuts.

In some exemplary embodiments, in order to replace a cut in Pure Decomposition Graph 501 with a replacement set program, every edge that is connected to the cut and leaves the cut (e.g., to the direction of execution), may be replaced with a setter. In some exemplary embodiments, every edge that is connected to the cut and enters the cut (e.g., from the direction of execution), may require to recreate the qubit states of the respective qubits (e.g., as determined by the circuit simulation). In some exemplary embodiments, it may be advantageous to select cuts that start at beginning of Quantum Circuit 500 and not at an intermediate portion of Quantum Circuit 500, at least since intermediate portions may have more edges that enter the cut, and thus may utilize more qubit resources.

In some exemplary embodiments, a quantum state of a qubit in the cut that is subsequently used by the remaining program, or outputted from the cut, may be recreated by the replacement set program. For example, a simple transformer may be used to create a replacement set program, based on input pure quantum states that are designated as states of input qubits, and output pure quantum states that are designated as states of output qubits. Simple transformers may be configured to create a quantum circuit that uses the input quantum states and creates the output quantum states. In some exemplary embodiments, a quantum state of a qubit in the cut that is not used subsequently by the remaining program, and is not used as an output from the cut, may not be recreated by the cut, e.g., thereby removing such qubits from the circuit. For example, such qubits may be released as auxiliary qubits by the simulator, e.g., using a setter or a reset operation. In one scenario, such as in case a cut comprises twelve input or auxiliary qubits and four pure output qubits, the output qubit states may be recreated by the setter, while the remaining twelve qubits may be removed without being recreated by the setter, thus releasing multiple qubits.

Referring now to FIGS. 6A-6B, showing exemplary selections of cuts in a pure decomposition graph, in accordance with some exemplary embodiments of the disclosed subject matter. In some exemplary embodiments, Pure Decomposition Graphs 600 and 601 may correspond to Pure Decomposition Graph 501 (FIG. 5).

As depicted in FIG. 6A, a Cut 610 may be selected in Pure Decomposition Graph 600. Cut 610 may comprise a connected component that obtains qubits 1, 2, and 3 in separate purity sets, and includes a Node 612 that combines qubits 1, 2, and 3 to a single purity set: {1, 2, 3}. There are no edges that enter Cut 610, at least since Cut 610 may be placed at a start of Pure Decomposition Graph 600. Edge 611, which may correspond to the pure set of qubits of {1, 2, 3}, may exit Cut 610.

In some cases, after selecting Cut 610 as a selected subcircuit, Cut 610 may be replaced with a replacement set program. Since Cut 610 is based on the Pure Decomposition Graph 600, Cut 610 may be determined not to be entangled with other portions of the circuit, and thus may be replaced with replacement set program. In some exemplary embodiments, the replacement set program may comprise a setter that prepares the same distributions as created by Node 612, directly. The number of resources used for executing a subcircuit with resulting distributions, may not be lesser than a number of resources used for executing a replacement set program that directly creates the resulting distributions. In some cases, in case the setter is estimated to utilize less resources than the selected subcircuit, it may be advantageous to replace the selected subcircuit with the setter. In case a same number of resources are used by both the selected subcircuit and the setter, it may not be advantageous to replace the selected subcircuit with the setter.

In some exemplary embodiments, FIG. 6B depicts a different selection of a cut. In some exemplary embodiments, FIG. 6B depicts a selection of a Cut 620 in Pure Decomposition Graph 601. Cut 620 may comprise a connected component that obtains qubits 1-7 in separate purity sets, and comprises Nodes 612, 614, and 616, which may correspond to Functions 410, 420, 430, and Inverse Function 412 of FIG. 4A, respectively. There are no edges that enter Cut 620, and four edges may exit Cut 620: edges corresponding to the purity sets {1}; {2}; {3}; and {4, 5, 6, 7}.

In some exemplary embodiments, the purity sets {1}; {2}; and {3} may not be utilized by the remaining program, and thus may be removed from the graph. In some exemplary embodiments, the purity set of {4, 5, 6, 7} may be utilized by the remaining program, and thus may be reconstructed by a setter. In some exemplary embodiments, in order to reconstruct the quantum states of the purity set {4, 5, 6, 7}, four or more qubits may be used by the setter to prepare such states. In case that more than four qubits are used for the state preparation, the additional qubits beyond the fourth qubit may be released after the states are created.

In other cases, any other cut may be selected in the pure decomposition graph. For example, the entire pure decomposition graph may be selected as a cut that includes a single exiting edge, e.g., Edge 619. The edge may be replaced with a single setter that sets the output qubit with the resulting quantum state. In some exemplary embodiments, after replacing a cut with a setter, the quantum circuit that corresponds to the pure decomposition graph may be modified accordingly, such as to replace a selected subcircuit that corresponds to Cut 620 with the replacement set program.

In some exemplary embodiments, replacing a cut with a set program may release resources, e.g., as depicted in FIG. 7. Referring now to FIG. 7, showing exemplary resources that are released by replacing a cut with a set program, in accordance with some exemplary embodiments of the disclosed subject matter. As depicted in FIG. 7, a quantum circuit may comprise a Compiled Portion 720, a Remaining Quantum Program 730 that may not be compiled. Replacing the Compiled Portion 720, or portions thereof, with a respective Set Program 722, may result with Released Resources 724, which may comprise released qubits, released cycles, released gates, or the like.

In some exemplary embodiments, different selections of cuts may result with different quantum circuits. For example, replacing Cut 610 (FIG. 6) with a set program, may be less efficient than replacing Cut 620 (FIG. 6) with a set program. For example, a first modified circuit resulting from replacing Cut 610 (FIG. 6) with a set program may utilize more resources than a second modified circuit resulting from replacing Cut 620 (FIG. 6) with a set program. Thus, the selection of a cut may comprise an influential decision that affects a resource utilization of the resulting circuit.

In some exemplary embodiments, in order to select one or more cuts in a pure decomposition graph, one or more cost functions may be utilized to estimate a cost of selecting each potential cut. In some exemplary embodiments, a cost of generating a replacement set program for replacing a cut may be calculated based on one or more predictors, heuristics, measurements, tables, libraries, historic data, or the like. For example, the cost function may be configured to receive a distribution of a qubit state, and output an evaluated cost of a set program that produces the same quantum state.

In some cases, a cost function may comprise a trained data-driven predictor, such as a deep learning agent, that is trained to estimate a number of resources that are required for creating any given distribution based on a labeled dataset that indicates for a set of distributions, their respective costs. In some cases, in order to estimate a cost of creating a distribution, the cost function may be configured to generate a test quantum circuit with a setter that creates the distribution, and to measure the number of resources that were utilized for executing the test quantum circuit. In some cases, the cost function may be configured in any other way, such as based on a retained database that retains costs of respective distributions.

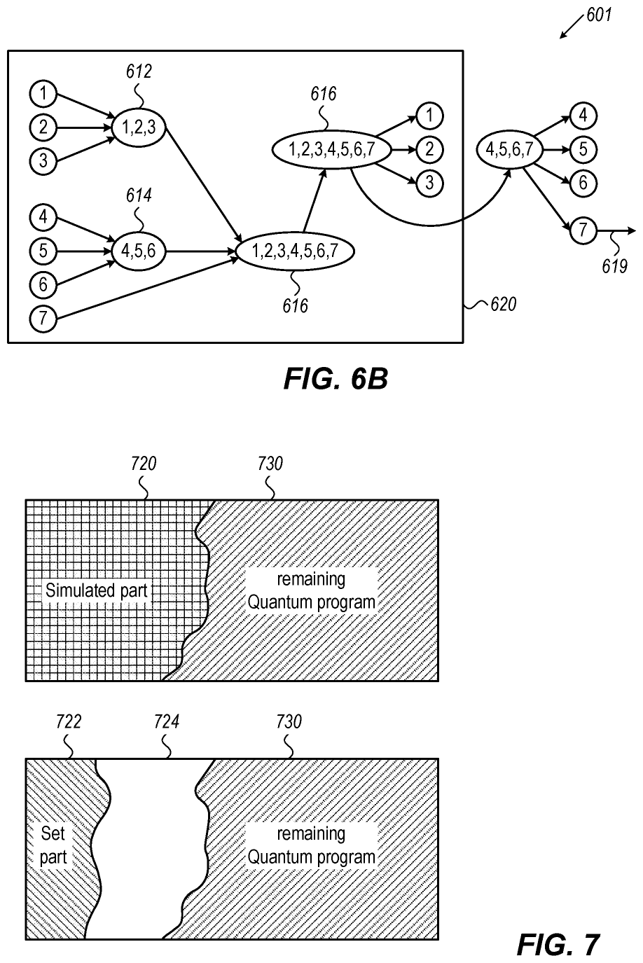

In some exemplary embodiments, the estimated cost of the set program may be compared to the estimated cost of executing the selected subcircuit in the cut (e.g., without replacing the cut). In some exemplary embodiments, based on the comparison, a resource-wise gain that can be obtained by replacing the cut with the set program may be determined, e.g., as depicted in FIG. 8A.

Referring now to FIG. 8A, showing exemplary method of selecting cuts, in accordance with some exemplary embodiments of the disclosed subject matter.

In some exemplary embodiments, Quantum Circuit 800 comprises qubits 1-11 that are manipulated by Nodes 810, 812, 814, 816, 820, 822, and 824. Each node may correspond to a subcircuit of Quantum Circuit 800, a functionality portion thereof, one or more gates thereof, or the like, all of each designating a pure set of qubits. In some exemplary embodiments, the nodes in Quantum Circuit 800 may correspond to nodes of a pure decomposition graph. In some cases, such as in case that qubits from a same purity set are wired to different gates, a node may be created as an intermediate destination of the qubits, from which the paths of the qubits may split. In some exemplary embodiments, the nodes may comprise purity sets, with one or more outputs that can be replaced with a setter.

In some exemplary embodiments, each node in Quantum Circuit 800 may be marked with a pair of values. In some exemplary embodiments, the pair of values may comprise a first value, e.g., a ‘current cost’, indicating a cost of a reaching the respective node. For example, the current cost may correspond to selecting a cut, in a respective pure decomposition graph, that starts at a beginning of the circuit and includes the node. In some exemplary embodiments, the pair of values may comprise a second value, e.g., a ‘alternative cost’, indicating a minimal cost of replacing the respective cut with a replacement set program that creates the same distributions (if used in the remaining program), as determined by the cost function.

For example, the current cost of Node 810 is 12 resource units, indicating that applying one or more gates of Node 810 on qubits 1 and 2 utilizes 12 resource units, and outputs a purity set that includes both qubits. The alternative cost of Node 810 is 6 resource units, indicating that the purity set of qubits 1 and 2 that is created by Node 810, can be created directly by a setter using 6 resource units. The remaining nodes Quantum Circuit 800 may similarly depict their current and alternative costs. As depicted in FIG. 8A, current and alternative costs of the nodes may monotonically increase, as the number of cycles increase. It is further noted that current and alternative costs of the nodes that obtain as input qubits that are outputted from previous nodes, may comprise at least a sum of the costs of the previous nodes.

In some exemplary embodiments, based on the current and alternative costs of the nodes, one or more nodes of Quantum Circuit 800 may be selected to be replaced with replacement set programs. For example, each selection of a node may correspond to selecting a respective cut in the corresponding pure decomposition graph. In some exemplary embodiments, one or more search algorithms, constraint solvers, optimizers, heuristics-based selectors, or the like, may be used to determine a selection of nodes that are estimated to conserve the greatest number of resources.

In the scenario of FIG. 8A, an optimal selection of nodes may comprise selecting Nodes 812, 814, 820, and 824. For example, selecting Node 812 may save 11 resource units (by subtracting the alternative cost of 6 from the current cost of 17). Similarly, selecting Node 814 may save 6 resource units, selecting Node 820 may save 2 resource units, and selecting Node 824 may save 4 resource units. It may not be optimal to select Node 816 instead of Nodes 812 and 814, at least since the saving of resources may be suboptimal compared to the saving obtained by selecting Nodes 812 and 814. Similarly, selecting Node 822 may be suboptimal, as it may not save any resources.

In some exemplary embodiments, the selection of nodes may be performed by applying a search algorithm on a space of the options for selecting nodes, to find a globally or locally optimal selection that provides the lowest costs, highest gains, or the like. For example, the search algorithm may comprise a gradual assent algorithm, a hill climbing algorithm, or any other local or global search algorithms. In some cases, the search algorithm may not be greedy, and may not search for a local optimum. For example, in case that a first node has a higher gain than a subsequent node, the first node may not be selected until a global determination is performed. Since selections of nodes may affect a possibility of selecting other nodes, it may be desired to identify a globally optimal selection of nodes. In other cases, the search algorithm may be greedy, may search for a local optimum, or the like. In some exemplary embodiments, the search algorithm may start from a beginning of a circuit and find nodes for replacement until reaching the end of the circuit, or start at any other area of the circuit, in any other order.

In some exemplary embodiments, the selection of nodes may or may not take into account a number of cycles associated to the node selections. For example, in case a same alternative cost is obtained by replacing cycles 0-7 of a circuit with a setter, and replacing cycles 0-14 of the circuit with the same setter, an objective function may be defined to ensure that the setter replaces cycles 0-14 with the setter, such as by assigning costs to each cycle and using an objective function to minimize such costs. In such cases, a desired tradeoff between costs and cycles may be defined.

In some cases, anode may or may not indicate one or more additional values, in addition to the pair of values, such as a value indicating a number of qubits needed for Quantum Circuit 800 to reach the node, a number of qubits needed for implementing a replacement set program, or the like. In such cases, the search algorithm may be configured to take into account the number of utilized qubits as an additional weighted or non-weighted cost.

In some cases, resources of quantum circuits may be released in any other way. For example, referring now to FIG. 8B, showing an exemplary modification of a quantum circuit, in accordance with some exemplary embodiments of the disclosed subject matter. In some cases, redundant qubits may be detected by obtaining a representation of a quantum circuit (815), simulating quantum states thereof, and identifying qubits that are in pure state and are not used be the remaining circuit (825). For example, a pure qubit may be used during a first set of cycles, and become redundant during the remaining cycles. In such cases, it may be desired to release the qubit to be reused during the remaining cycles. Identified qubits may be released by modifying the circuit to comprise a setter that transforms the purity sets of qubits to zero states (835), such as using a simple transformer. In other cases, qubits may be released by modifying the circuit to comprise measurers that initialize the quantum states of the identified qubits (845). In other cases, the redundant qubits may be released in any other way.

Referring back to FIG. 2, on Step 250, after modifying the quantum circuit, a recompilation process of the modified quantum circuit may be performed. For example, the recompilation may be performed after executing the simulator and performing circuit modifications to simulated portions of the circuit.

In some exemplary embodiments, a modified quantum circuit may be obtained by modifying the representation of the original quantum circuit according to Steps 242, 244, and 246, alone or in combination. In some exemplary embodiments, the circuit's resource utilization may be optimized by modifying the circuit representation, resulting with released resources. In some exemplary embodiments, the modified quantum circuit may comprise released resources, such as released qubits. In some exemplary embodiments, it may be challenging to utilize the released resources for other purposes. For example, when instantiating the modified quantum circuit, a back-end compiler may not be able to use a released qubit in case the quantum circuit is already compiled by the front-end compiler, and the released qubit may remain idle. Thus, the modified quantum circuit may be recompiled.

It is noted that the recompilation process may include compilation from scratch. Additionally, or alternatively, the recompilation process may utilize existing computations by the compiler that were computed during the initial compilation. For example, resources maintained by the compiler may be updated based on the modifications made to the circuit or sub-circuit being recompiled, while reusing previous computations made during the initial compilation.

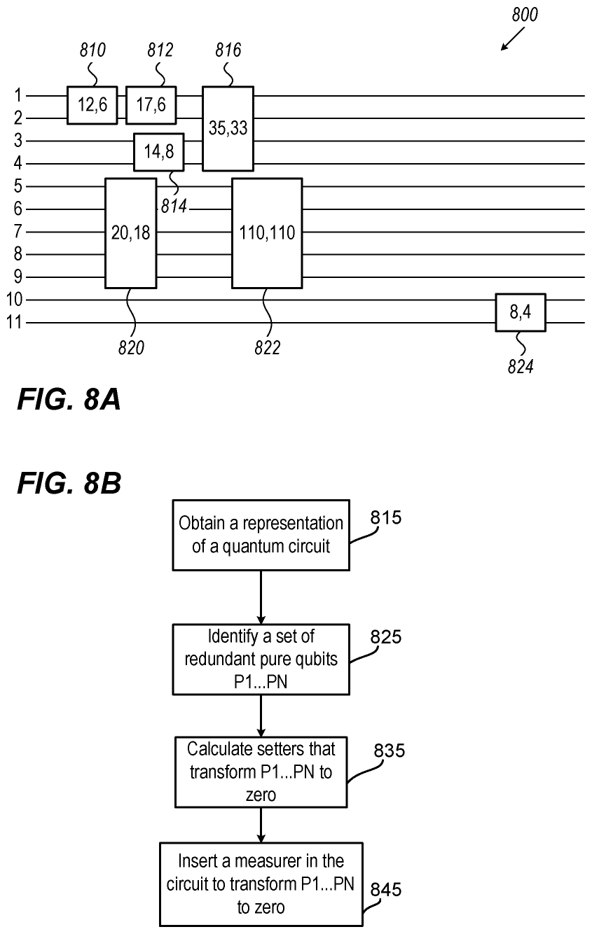

Referring now to FIG. 9, showing an exemplary compilation process, in accordance with some exemplary embodiments of the disclosed subject matter.

As depicted in FIG. 9, a Quantum Program 910, such as a DAG representation, may be at least partially compiled by a front-end compiler to a respective Quantum Circuit 920. In some exemplary embodiments, the simulator may be executed over a portion of Quantum Circuit 920, such as in order to determine values of qubit states, in order to generate a respective pure decomposition graph, or the like. In some exemplary embodiments, based on the simulation, an optimizer may be executed over Quantum Circuit 920. In some exemplary embodiments, the optimizer may utilize the simulation results in order to modify the Quantum Circuit 920, remove redundant gates thereof, reuse its qubits, replace selected subcircuits thereof with replacement set programs, or the like. In some exemplary embodiments, the optimizer may generate a modified version of Quantum Circuit 920, which may be further compiled by a back-end compiler to obtain respective Machine Instructions 930.

In some exemplary embodiments, in case the optimizer releases resources, the back-end compiler may not be able to make use of the released resources, at least since the back-end compiler may rely on the compilation of the front-end compiler for determining qubit roles, for memory allocation, or the like. For example, the back-end compiler may rely on an auxiliary table of the front-end compiler, which indicates which qubits are free to be used as auxiliary qubits.

In some exemplary embodiments, in order to enable the back-end compiler to make use of the released resources, the modified quantum circuit that is obtained by executing the optimizer over Quantum Circuit 920, may be recompiled. In some exemplary embodiments, a recompilation of the modified circuit may be performed in order to provide an indication of the released resources to the front-end compiler, and from there to the back-end compiler.

In some cases, in order to conserve resources, the first compilation of the original quantum circuit, as performed on Step 220, may comprise a partial compilation. In some exemplary embodiments, the front-end compiler may compile at least some selected code portions of the quantum program, followed by simulation and optimization processes that may be executed over the compiled code portions (e.g., including the respective representation of the quantum circuit). In some cases, the front-end compiler may be paused, or terminated, after compiling the selected code portion, before reaching the remaining code portions of the quantum program. In some exemplary embodiments, the execution of the simulation may drive an optimization of the compiled portions of the circuit, such as by replacing the compiled code with optimized code, replacing a portion of the quantum program with the optimized code, or the like.

In some exemplary embodiments, while the front-end compiler compiles the selected code, it may maintain data structures associated with the generated code. For example, the front-end compiler may maintain an auxiliary table, indicating which qubits are free to be used as auxiliary qubits. In some exemplary embodiments, after the compiled code is replaced with the optimized code, the front-end compiler may recompile the optimized code, and update the maintained data structures accordingly. For example, in case the optimized code releases a qubit, an auxiliary table that is maintained by the compiler may be updated with the released qubit becoming an auxiliary qubit. In some exemplary embodiments, after the compilation of the optimized code, the front-end compiler may continue a compilation of the remaining portions of the code, which were not compiled by the compiler. For example, the front-end compiler may be enabled to continue to progress over the remaining quantum program, thus compiling the remaining portion of the program only once. This may save computational resources compared to performing a full compilation of the circuit before and after the circuit modifications.

In some exemplary embodiments, after recompiling the optimized code, the optimized code may or may not be re-simulated to identify any other potential amendments, e.g., iteratively, until no modifications are further performed. For example, in case the modification includes selecting cuts in a pure decomposition graph and replacing the cuts with replacement set programs, the optimized circuit may be recompiled to generate a new pure decomposition graph, in order to determine whether additional optimizations may be performed, and such re-simulations may be performed iteratively, until no more changes are performed. After the re-simulations and respective modifications are performed, the remaining code portions may be compiled.

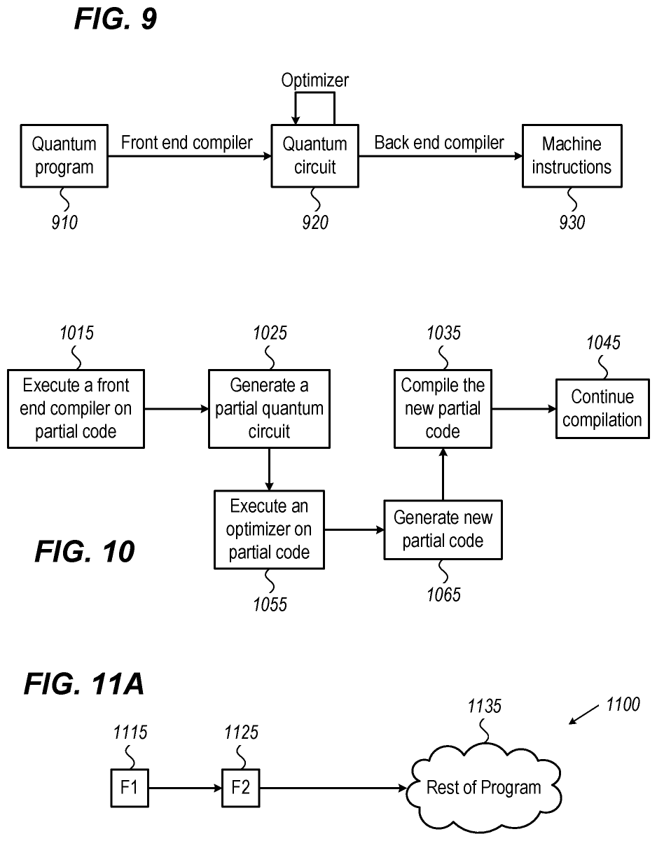

Referring now to FIG. 10, showing an exemplary process for reusing the front-end compiler after the circuit modifications, in accordance with some exemplary embodiments of the disclosed subject matter. In some exemplary embodiments, the process includes executing a front-end compiler (1015) on a partial code of a quantum program, to obtain a representation of a partial quantum circuit (1025). A simulator is executed on the partial quantum circuit to determine quantum states, quantum state data, or the like. An optimizer is executed on the partial code of the quantum program (1055), and uses the simulated quantum states to modify the code. For example, the optimizer may perform optimizations based on the simulation. The optimizer may generate new partial code (1065). The front-end compiler may then compile the new partial code (1035), such as to obtain a new partial quantum circuit replacing the original partial quantum circuit. The front-end compiler may update the respective data structures that are maintained by the front-end compiler accordingly. The front-end compiler may continue compilation of the remaining code of the quantum program (1045).

Referring back to FIG. 2, the type of compilers that are used for the compilation and the re-compilation, such as the front-end and back-end compilers, may affect a modification of the circuit. Compiler types may comprise gate-level compilers that can compile gate-level portions of a circuit representation, function-level compilers that can compile functions of a high level circuit representation (e.g., of a DAG), or the like.

For example, a function-level compiler may be executed on a representation of a quantum circuit such as a DAG that comprises functions, connections between the functions, or the like. In some exemplary embodiments, the function-level compiler may obtain, for each function, one or more respective instances that comprise executable implementations of the function. For example, such instances may be retained in a repository, an instance library, a cloud, or the like, and may be available to the compiler. In some exemplary embodiments, when compiling the representation, the compiler may select instances from a library retaining the function instances, such as according to quantum resources that are available on a respective quantum computer, properties of the instances, or the like.

In some exemplary embodiments, the selection of circuit modifications, such as selecting cuts for Step 246, may depend on a type of compiler that is used. In some exemplary embodiments, using gate-level compilers and using function-level compilers may enable different modifications to be performed. For example, in case of a functional-level compiler that is used on Step 220, the cuts of Step 246 may be selected only at the function barriers, such as without splitting a function into two. In some exemplary embodiments, placing cuts at function barriers may be beneficial for a functional-level compiler, at least since it may enable the functional-level compiler to add to an instance library new instances for functions of the quantum circuit, which may be used in the recompilation process. In some exemplary embodiments, the modifications to the functions may be used to generate new functions instances or new composite function instances, and these instances may be made available to the compiler, such as by adding them to an instance library that is available for the compiler.

For example, in case of a composite function instance that implements two or more functions, the composite function instance may be retained in the instance library with an indication that the instance is associated to the respective functions, with respective properties thereof, or the like. For example, a cut that comprises two functions may be replaced with a setter that uses less qubits, and the setter may be instantiated and added to an instance library to be used during the recompilation of Step 250.

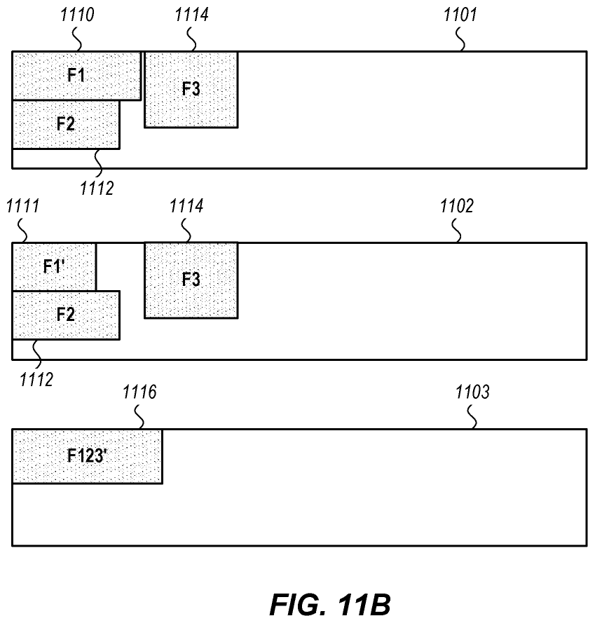

Referring now to FIGS. 11A-11B, showing exemplary scenarios of using a function-level compiler, in accordance with some exemplary embodiments of the disclosed subject matter.

In some exemplary embodiments, as depicted in FIG. 11A, Quantum Program 1100 may comprise a high level representation of a quantum circuit, such as a DAG representation of different functions of Quantum Program 1100. For example, Quantum Program 1100 may comprise Function 1115 (denoted F1) and Function 1125 (denoted F2), which represents respective functions of the program, and Subprogram 1135 (denoted F3), which represents the rest of the quantum program. In some exemplary embodiments, when using a function-level compiler, an instance library may retain four instances that implement Function 1115, and three instances that implement Function 1125.

In some exemplary embodiments, when optimizing the DAG, a simulator may be executed over a compiled portion of Quantum Program 1100, and may extract quantum states of qubits therefrom. In some exemplary embodiments, an optimizer may utilize the extracted states to modify the Quantum Program 1100, such as by replacing Function 1115 with a replacement set program that produces the same distributions (e.g., in accordance with Step 246). In such a case, the modified function may be instantiated, and the newly generated instance may be added to the instance library, in association with Function 1115, thereby retaining five instances that implement Function 1115. In some exemplary embodiments, Quantum Program 1100 may be recompiled with the new instances. For example, the function-level compiler may select the new instance for implementing Function 1115, at least since it may utilize less resources than the alternative instances.

In some cases, the function-level compiler may be enabled to replace multiple functions, over a cross-function boundary, with a single composite instance. For example, the function-level compiler may replace a subprogram that includes Functions 1115 and 1125. In such cases, a composition of the functionalities of Function 1115 and Function 1125 may be replaced with a modified program, which may be instantiated and added to the instance library. The newly generated composite instance may be retained together with metadata indicating that the composite instance implements a composition of Function 1115 and Function 1125. During execution, the compiler may select the new instance for implementing Functions 1115 and 1125, at least since it may utilize less resources than selecting a first instance for Function 1115 and a second instance for Function 1125.

As another example, as depicted in FIG. 11B, a Quantum Program 1101 may comprise Functions 1110, 1112, and 1114. In some cases, Quantum Program 1101 may be optimized, such as by replacing Function 1110 with Function 1111. For example, Function 1111 may comprise a setter that creates the output of Function 1110 directly. In such cases, an instance implementing Function 1111 may be generated and added to an instance library. In such cases, the modified quantum circuit, Quantum Program 1102, may utilize less resources than Quantum Program 1101.

In some cases, a Composite Instance 1116 may be used to implement all three functions: Functions 1110, 1112, and 1114. For example, Composite Instance 1116 may comprise a setter that creates the output of Functions 1110, 1112, and 1114 directly. In such cases, the modified quantum circuit, Quantum Program 1103, may utilize less resources than Quantum Program 1102.

Referring back to FIG. 2, on Step 260, the modified quantum circuit may be executed on a quantum computer, e.g., multiple times. For example, the modified quantum circuit may be instantiated using a front-end compiler, a back-end compiler, or the like, and the instance may be executed hundreds or thousands of time, and sampled using tomography, in order to provide a statistically significant estimate of the outputted distribution of the circuit.

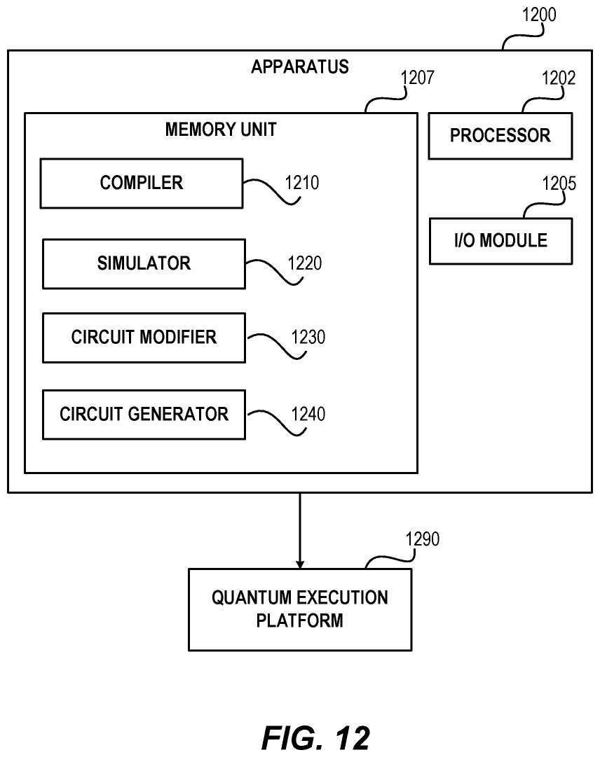

Referring now to FIG. 12 showing a block diagram of an apparatus, in accordance with some exemplary embodiments of the disclosed subject matter.

In some exemplary embodiments, Apparatus 1200 may comprise one or more Processor(s) 1202. Processor 1202 may be a Central Processing Unit (CPU), a microprocessor, an electronic circuit, an Integrated Circuit (IC) or the like. Processor 1202 may be utilized to perform computations required by Apparatus 1200 or any of its subcomponents. It is noted that Processor 1202 may be a traditional classical processor, and not necessarily a quantum processor.

In some exemplary embodiments of the disclosed subject matter, Apparatus 1200 may comprise an Input/Output (I/O) module 1205. I/O Module 1205 may be utilized to provide an output to and receive input from a user, an apparatus, or the like, such as, for example to obtain a quantum program from a user.

In some exemplary embodiments, Apparatus 1200 may comprise Memory 1207. Memory 1207 may be a hard disk drive, a Flash disk, a Random Access Memory (RAM), a memory chip, or the like. In some exemplary embodiments, Memory 1207 may retain program code operative to cause Processor 1202 to perform acts associated with any of the subcomponents of Apparatus 1200. Memory 1207 may comprise one or more components as detailed below, implemented as executables, libraries, static libraries, functions, or any other executable components.

In some exemplary embodiments, Memory 1207 may comprise one or more components, such as a Compiler 1210, which may comprise a front-end compiler, a back-end compiler, or the like. In some exemplary embodiments, Compiler 1210 may be configured to obtain a quantum program, a representation of a quantum circuit, or the like, such as from I/O Module 1205, and to perform at least a partial compilation thereof. For example, Compiler 1210 may estimate that a subcircuit of a quantum circuit may be successfully simulated by Simulator 1220, and may perform a compilation of the subcircuit. In other cases, Compiler 1210 may perform a fully compilation of the program.

In some exemplary embodiments, Memory 1207 may comprise a Simulator 1220, which may obtain a partially or fully compiled circuit from Compiler 1210, and attempt to simulate the circuit for as long as possible. Simulator 1220 may measure quantum state data, such as values of quantum states of qubits, purity sets of qubits, or the like. For example, Simulator 1220 may generate a pure decomposition graph of the program.

In some exemplary embodiments, Memory 1207 may comprise a Circuit Modifier 1230, which may be configured to obtain from Simulator 1220 information associated with quantum states of qubits, and utilize such information to modify the quantum circuit. For example, Circuit Modifier 1230 may remove gates from the circuit, configure qubits to be reutilized, replace selection subcircuits with replacement set programs, clean redundant qubits, or the like.

In some exemplary embodiments, Compiler 1210 may recompile the modified program, circuit, or the like, to thereby obtain a compiled modified circuit. In some exemplary embodiments, Memory 1207 may comprise a Circuit Generator 1240, which may be configured to synthesize, or generate, an instance of the compiled modified circuit. In some exemplary embodiments, the resulting instance may be executed multiple times on a Quantum Execution Platform 1290, and sampled to estimate the resulting distribution.

The present disclosed subject matter may be a system, a method, and/or a computer program product. The computer program product may include a computer readable storage medium (or media) having computer readable program instructions thereon for causing a processor to carry out aspects of the present disclosed subject matter.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), electrical signals transmitted through a wire, Quantum Random Access Memory (QRAM), photons, trapped ions, lasers, cold atoms, or the like.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present disclosed subject matter may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server (or a group of multiple remote servers). In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosed subject matter.

Aspects of the present disclosed subject matter are described herein with reference to flowchart illustrations and/or block diagrams of methods, apparatus (systems), and computer program products according to embodiments of the disclosed subject matter. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present disclosed subject matter. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The terminology used herein is for the purpose of describing particular embodiments only and is not intended to be limiting of the disclosed subject matter. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present disclosed subject matter has been presented for purposes of illustration and description but is not intended to be exhaustive or limited to the disclosed subject matter in the form disclosed. Many modifications and variations will be apparent to those of ordinary skill in the art without departing from the scope and spirit of the disclosed subject matter. The embodiment was chosen and described in order to best explain the principles of the disclosed subject matter and the practical application, and to enable others of ordinary skill in the art to understand the disclosed subject matter for various embodiments with various modifications as are suited to the particular use contemplated.

What is claimed is:

1. A method comprising:
obtaining quantum state data that is determined based on a simulation of a portion of a quantum circuit, the quantum circuit is configured to manipulate a plurality of qubits over a plurality of cycles using a plurality of gates, the portion of the quantum circuit is configured to prepare one or more input values on one or more input qubits of the quantum circuit, the portion of the quantum circuit is configured to produce an output value based on a manipulation of the one or more input qubits when having the one or more input values, the quantum state data comprising the one or more input values and the output value;
based on the quantum state data, determining a modification of the quantum circuit;
based on said determining the modification of the quantum circuit, generating a modified quantum circuit, the modified quantum circuit is configured to produce the output value; and
executing the modified quantum circuit on a quantum computer.

2. The method of claim 1, wherein said determining the modification comprises determining that a quantum gate of the quantum circuit is redundant for preparing the output value based on the quantum state data, wherein the quantum gate is not redundant for all potential input values of the quantum circuit and is redundant with respect to the one or more input values, wherein the modified quantum circuit is generated by removing the quantum gate from the quantum circuit.

3. The method of claim 1, wherein said determining the modification comprises determining that, when the quantum circuit is set with the one or more input values on the one or more input qubits, a two-qubit quantum gate of the quantum circuit can be replaced with a one-qubit quantum gate without affecting the output value, wherein the modified quantum circuit is generated by replacing the two-qubit quantum gate with the one-qubit quantum gate.

4. The method of claim 3, wherein said determining that the two-qubit quantum gate can be replaced with the one-qubit quantum gate comprises determining that first and second qubits of the plurality of qubits are attached to the two-qubit quantum gate, and, when the quantum circuit is set with the one or more input values on the one or more input qubits, the two-qubit quantum gate manipulates only the first qubit, and not the second qubit, wherein the one-qubit quantum gate is generated to be attached to the first qubit.

5. The method of claim 1, wherein said determining the modification comprises determining that, when the quantum circuit is set with the one or more input values on the one or more input qubits, a qubit of the quantum circuit can be reused, the quantum state data comprising a quantum state value of the qubit, wherein the modified quantum circuit is generated by inversing the quantum state value on the qubit.

6. The method of claim 1, wherein said determining the modification comprises determining that, when the quantum circuit is set with the one or more input values on the one or more input qubits, a subcircuit of the quantum circuit can be replaced with a set program, wherein the modified quantum circuit is generated by replacing the subcircuit with the set program.

7. The method of claim 6, wherein the subcircuit is configured to produce the output value, wherein the set program comprises a quantum state setter that prepares the output value.

8. The method of claim 6, wherein said determining that the subcircuit can be replaced with the set program is performed based on an identification that the subcircuit does not divide any purity sets, the identification is based on the quantum state data.

9. The method of claim 8, wherein the identification is based on a pure decomposition graph that is generated based on the quantum state data, wherein the pure decomposition graph indicates, for each stage of the simulation, which qubits of the quantum circuit belong to which purity sets.

10. The method of claim 9, wherein first and second qubits belong to a same purity set, wherein the first and second qubits are entangled with each other, wherein the first and second qubits are not entangled with any other qubit of the plurality of qubits.

11. The method of claim 9, wherein each of the qubits of the quantum circuit comprises an individual qubit or a qubit register.

12. The method of claim 9, wherein the pure decomposition graph comprises a Directed Acyclic Graph (DAG).

13. The method of claim 1, wherein the modification of the quantum circuit is configured to reduce a resource utilization of the quantum circuit when the quantum circuit is set with the one or more input values on the one or more input qubits, the resource utilization relating to at least one of: a qubit resource, a cycle resource, and a gate resource.

14. The method of claim 1, wherein said executing the modified quantum circuit is performed multiple times in order to measure an output of the modified quantum circuit.

15. The method of claim 14, wherein the output of the modified quantum circuit is identical to an output of the quantum circuit, whereby the modification of the quantum circuit does not affect the output of the quantum circuit.

16. The method of claim 1, wherein the portion of the quantum circuit is obtained by compiling a first subcircuit of the quantum circuit, and not compiling a second subcircuit of the quantum circuit.

17. The method of claim 16, wherein the second subcircuit is determined not to be compiled based on an estimation that a simulator that is configured to perform the simulation will exhaust a predetermined number of resources before simulating the second subcircuit.

18. The method of claim 1, wherein the quantum circuit comprises a first subcircuit and a second subcircuit, wherein the portion corresponds to the first subcircuit, wherein the method further comprises:
compiling the first subcircuit, thereby obtaining a compiled portion;
pausing a compilation process;
performing said generating, thereby modifying the first subcircuit to a modified first subcircuit;
recompiling the modified first subcircuit; and
continuing the compilation process to compile the second subcircuit, whereby the second subcircuit is only compiled once.

19. An apparatus comprising a processor and coupled memory, said processor being adapted to:
obtain quantum state data that is determined based on a simulation of a portion of a quantum circuit, the quantum circuit is configured to manipulate a plurality of qubits over a plurality of cycles using a plurality of gates, the portion of the quantum circuit is configured to prepare one or more input values on one or more input qubits of the quantum circuit, the portion of the quantum circuit is configured to produce an output value based on a manipulation of the one or more input qubits when having the one or more input values, the quantum state data comprising the one or more input values and the output value;
based on the quantum state data, determine a modification of the quantum circuit;
based on said determine the modification of the quantum circuit, generate a modified quantum circuit, the modified quantum circuit is configured to produce the output value; and
execute the modified quantum circuit on a quantum computer.

20. The apparatus of claim 19, wherein the processor is adapted to determine the modification of the quantum circuit in order to reduce a resource utilization of the quantum circuit when the quantum circuit is set with the one or more input values on the one or more input qubits, the resource utilization relating to at least one of: a qubit resource, a cycle resource, and a gate resource.

21. A computer program product comprising a non-transitory computer readable medium retaining program instructions, which program instructions when read by a processor, cause the processor to:
obtain quantum state data that is determined based on a simulation of a portion of a quantum circuit, the quantum circuit is configured to manipulate a plurality of qubits over a plurality of cycles using a plurality of gates, the portion of the quantum circuit is configured to prepare one or more input values on one or more input qubits of the quantum circuit, the portion of the quantum circuit is configured to produce an output value based on a manipulation of the one or more input qubits when having the one or more input values, the quantum state data comprising the one or more input values and the output value;
based on the quantum state data, determine a modification of the quantum circuit;
based on said determine the modification of the quantum circuit, generate a modified quantum circuit, the modified quantum circuit is configured to produce the output value; and
execute the modified quantum circuit on a quantum computer.
